(19) United States
(12) Patent Application Publication
(10) Pub. No.: US 2011/0282868 A1
(43) Pub. Date: Nov. 17, 2011

(54) SEARCH METHOD, INTEGRATED SEARCH SERVER, AND COMPUTER PROGRAM

(75) Inventor: YOHSUKE ISHII, Yokohama (JP)

(73) Assignee: Hitachi Solutions Ltd.

(21) Appl. No.: 13/032,094

(22) Filed: Feb. 22, 2011

(30) Foreign Application Priority Data
May 13, 2010 (JP) 2010-111314

(51) Int. Cl. G06F 17/30

(52) U.S. Cl. 707/722; 707/E17.014

(57) ABSTRACT

In a system in which multiple independent search servers are loosely coupled, a duplicate entry is detected and eliminated from search results sent from the respective search servers with respect to the same search condition. An integrated search control part of the search server, upon receiving an integrated search request, determines a hash algorithm to be used in common by the respective search servers. Each search control part responds to the integrated search control part by adding a hash value, based on this hash algorithm, to the search result. The integrated search control part detects and eliminates a duplicate entry on the basis of the hash value.

### CROSS-REFERENCE TO RELATED APPLICATIONS

This application relates to and claims priority from Japanese Patent Application No. 2010-111314 filed on May 13, 2010, the entire disclosure of which is incorporated herein by reference.

### BACKGROUND OF THE INVENTION

1. Field of the Invention

The present invention relates to a search method, an integrated search server and a computer program.

2. Description of the Related Art

In a full text search service, the search server analyzes file data stored in a computer system, and creates a search index beforehand. The search server uses the search index to provide the search service to a user. The user sends the search server a search query for searching for a file he wishes to acquire, and accesses the target file on the basis of the result of this search. Because the number of files being stored in computer systems is increasing every year, the full text search service is an important service for users.

However, in a case where multiple search servers exist, the user must issue a search query to each server individually, and acquire the search results individually from each search server. For this reason, usability is poor.

Consequently, in recent years integrated search services that enable the search results from respective search servers to be acquired in an integrated manner by simply issuing a search request one time to multiple independent search servers are being provided.

For example, the integrated search specification called OpenSearch has been made public, and integrated search services that make use of this specification are being provided. In an integrated search service, each search server is operated independently. In the meantime, each search server is able to receive a search request based on an integrated standard interface like OpenSearch. In accordance with this, an integrated search that loosely couples multiple search servers becomes possible. In a loosely coupled integrated search, opportunities for updating a search algorithm or a search index used by each search server will differ respectively.

Alternatively, there is also a mode for providing a closely coupled integrated search service by integrally operating multiple search servers. In a closely coupled integrated search service, each search server utilizes the same search algorithm, and the search index is also integratively updated inside the system. An integrated search service that closely couples multiple search servers can also be viewed as a single search server.

In addition, a search server comprising a function for excluding duplicate content from within a search result is also known. Specifically, the search server detects a duplicate entry based on a hash value created from each entry of the search result, and deletes the duplicate entry from the search result (U.S. Pat. No. 7,366,718 B1).

The problem is that the technology disclosed in the above-mentioned literature only makes it possible to delete a duplicate entry inside the respective search servers; it is virtually impossible to detect a duplicate entry with respect to an integrated search result that integrates the respective search results from multiple search servers.

This is because there is the likelihood that in the case of an integrated search service in a mode that loosely couples multiple search servers, the hash algorithm used to detect a duplicate entry will differ for each search server. In a case where the hash algorithm used by each search server is different, it is extremely difficult to detect a duplicate entry on the basis of a hash value. Therefore, in the technology disclosed in the above-mentioned literature, it is not possible to detect a duplicate entry included in an integrated search result in a system in which multiple search servers are loosely coupled.

The above-described problem is caused by the fact that it is difficult to standardize the hash algorithms used in duplicate entry detection among respective search servers. Various hash algorithms already exist, and various new hash algorithms will probably also emerge and be implemented on search servers in the future as well. In addition, the prerequisites required for each hash algorithm will differ for each search server.

For the above-stated reasons, it is virtually impossible to standardize a hash algorithm among multiple search servers that are being operated independently. Therefore, the prior art disclosed in the above-mentioned literature cannot be applied to an integrated search service in which multiple search servers are loosely coupled.

### SUMMARY OF THE INVENTION

Consequently, an object of the present invention is to provide a search method, an integrated search server and a computer program that make it possible to detect and deduplicate data from search results in a system in which multiple search servers are loosely coupled. Further objects of the present invention should become clear from the description of the embodiment explained hereinbelow.

A search method according to a first aspect of the present invention for solving the above-stated problem is a method for searching in use of a computer system comprising multiple search servers, wherein the computer system is configured by loosely coupling independently operated multiple search servers, and an integrated search server, which is included among the multiple search servers, upon receiving an integrated search request to have multiple prescribed search servers included among the multiple search servers carry out respective searches, determines duplicate search information, which can be used in common by the prescribed search servers and which is for detecting a duplicate, and issues a search request corresponding to the integrated search request to the respective prescribed search servers, each prescribed search server searches a data group for which each prescribed search server is responsible on the basis of the search request, includes in the result of this search a duplicate detection value, which has been created using the determined duplicate detection information and which is for detecting a duplicate, and sends this search result to the integrated search server, and the integrated search server, based on the respective duplicate detection values, detects the duplicate data from among the detection results received from the prescribed search servers, removes the duplicate data detected in the search results in order to create an integrated search result, and provides this integrated search result to the source of the integrated search request.

In a second aspect according to the first aspect, each prescribed search servers respectively stores beforehand a duplicate detection value for each of multiple duplicate detection information with respect to the data group for which the prescribed server is responsible, includes in the search result from among the stored duplicate detection values, the duplicate detection value corresponding to the duplicate detection information determined by the integrated search server, and sends this search result to the integrated search server.

In a third aspect according to the second aspect, each prescribed search server, when updating a search index used for searching the data group for which the prescribed search server is responsible, respectively creates and stores duplicate detection values for each of the multiple duplicate detection information.

In a fourth aspect according to the first aspect, the integrated search server acquires from each of the prescribed search servers information related to duplicate detection information that can be used by each prescribed search server and stores the same, and upon receiving an integrated search request, determines, based on information related to the stored duplicate detection information, duplicate detection information that the prescribed search servers can use in common.

In a fifth aspect according to the first aspect, the integrated search server, when the computer system is to be built, acquires from each of the prescribed search servers information related to duplicate detection information that can be used by the respective prescribed search servers and stores the same, and upon receiving an integrated search request, determines, based on information related to the stored duplicate detection information, duplicate detection information that the prescribed search servers can use in common.

In a sixth aspect according to the first aspect, each prescribed search server, in a case where a search request has been received from the integrated search server, creates a duplicate detection value in accordance with the determined duplicate detection information, includes this duplicate detection value in the search result, and sends this search result to the integrated search server.

In a seventh aspect according to the first aspect, the duplicate detection information is a hash algorithm, and the duplicate detection value is a hash value.

The present invention can be understood as an integrated search server for carrying out a search using a computer system configured by loosely coupling multiple search servers that are each operated independently, or a computer program for causing a computer to function as an integrated search server. Furthermore, a combination other than a combination of the above-mentioned aspects may also be included in the scope of the present invention. The computer program can be distributed via either a communication medium or a recording medium.

### BRIEF DESCRIPTION OF THE DRAWINGS

FIG. 1 is a diagram showing the overall configuration of a computer system;

FIG. 2 is a diagram showing the hardware configuration of a search server;

FIG. 3 is a diagram showing the configuration of computer programs that are stored in the search server;

FIG. 4 is a diagram showing the configuration of tables that are stored in the search server;

FIG. 5 is a diagram showing the hardware configuration of a file server;

FIG. 6 is a block diagram showing the hardware configuration of a client machine;

FIG. 7 is a diagram schematically showing a series of integrated search processes;

FIG. 8 shows a table for managing a file registered in a search index;

FIG. 9 shows a table for managing the search index;

FIG. 10 shows a table for managing the search server;

FIG. 11 shows a table for temporarily storing an integrated search result;

FIG. 12 shows an example of the configuration of an integrated search request parameter;

FIG. 13 shows an example of the configuration of a response parameter of an integrated search result;

FIG. 14 shows an example of the configuration of a hash algorithm query request parameter;

FIG. 15 shows an example of the configuration of a response parameter of a hash algorithm query;

FIG. 16 shows an example of the configuration of a search request parameter;

FIG. 17 shows an example of the configuration of a search result response parameter;

FIG. 18 is a flowchart showing an integrated search request process;

FIG. 19 is a flowchart showing an integrated search process;

FIG. 20 is a continuation of the flowchart of FIG. 19;

FIG. 21 is a flowchart showing a process for responding to a hash algorithm query;

FIG. 22 is a flowchart showing a process for carrying out a search and responding with a search result;

FIG. 23 is a flowchart showing a process for updating a search index;

FIG. 24 is a continuation of the flowchart of FIG. 23;

FIG. 25 shows an example of the configuration of a table for managing the search server related to a second example;

FIG. 26 is a flowchart showing a portion of the integrated search process;

FIG. 27 shows an example of the configuration of a computer program of the search server related to a third example;

FIG. 28 is a flowchart showing a process for negotiating a hash algorithm in advance;

FIG. 29 is a flowchart showing a search response process related to a fourth example;

FIG. 30 is a flowchart showing a portion of the integrated search process related to a fifth example;

FIG. 31 shows a table related to a sixth example for temporarily storing an integrated search result;

FIG. 32 is a flowchart showing a portion of the integrated search process; and

FIG. 33 is a flowchart related to a seventh example showing a process for notifying the search server of a duplicate entry.

### DESCRIPTION OF THE SPECIFIC EMBODIMENTS

An embodiment of the present invention will be explained below on the basis of the drawings. In this embodiment, a processing scheme for a search server to detect and deduplicate content from an integrated search result will be explained. As will be explained in detail hereinbelow, in this embodiment, a hash algorithm, which is used by each search server that carries out a search, is determined in advance, and a hash value, which is computed in accordance with this determined hash algorithm, is included in a search result, and this search result is sent to an integrated search server. The hash value is used to detect and remove a duplicate entry.

### Example 1

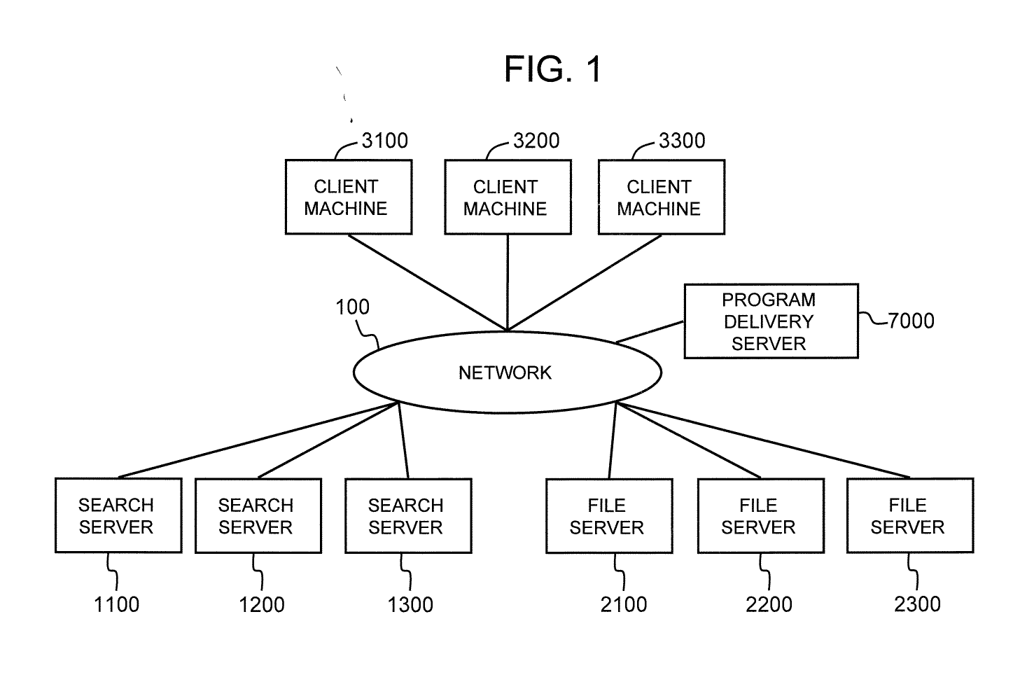

FIG. 1 is a schematic diagram showing an example of the configuration of a system in accordance with this example.

Multiple search servers 1100, 1200, 1300, multiple file servers 2100, 2200, 2300, and multiple client machines 3100, 3200, 3300 are coupled via a communication network 100. In addition, a server 7000 for delivering a computer program is also coupled to the communication network 100.

In this system, the corresponding search server creates a search index for the data stored in each file server. Each search server uses this search index to provide a search service to a client machine with respect to a file of a file server. In addition, the search server also provides the client machine with an integrated search service, which collects search results from multiple search servers for provision to the client machine.

Specifically, the service content is as follows. First, the client machine can register a file (a data file) in a file server. The file server stores and maintains the registered file in an external storage apparatus that is coupled to the relevant file server. The search server acquires the file that was stored in the file server using crawling and creates a search index. The search server stores and maintains the search index in an external storage apparatus that is coupled to the relevant search server.

The client machine can specify a search query and send a search request to the search server. The search server selects a file that matches the condition of this search query using the search index of the relevant search server, and provides this search result to the client machine.

In addition, the client machine can specify a search query and send an integrated search request to the search server. The search server selects a file that matches the condition of this search query using the search index of the relevant search server. In addition, the search server also sends the search request to another search server that is capable of an integrated search, and provides the search results received from each search server to the client machine as an integrated search result.

The client machine, based on the integrated search result, can select an access-target file. The client machine can use a file pathname for file access that is stored in the integrated search result to access the file maintained in the file server.

Furthermore, in FIG. 1, three types of apparatuses—the search server, the file server, and the client machine—are shown as respectively different apparatuses. The present invention is not limited to the configuration shown in FIG. 1, and, for example, either any two or all three of these three types of apparatuses may be configured as a single computer apparatus.

The program delivery server 7000, for example, is an apparatus for delivering a hash algorithm or other such program to a search server. The program delivery server, for example, may be integrated with either the file server or the search server and realized in a single computer apparatus.

In addition, the coupling mode of the communication network 100 may be either an internet coupling or an intranet coupling in accordance with a local area network.

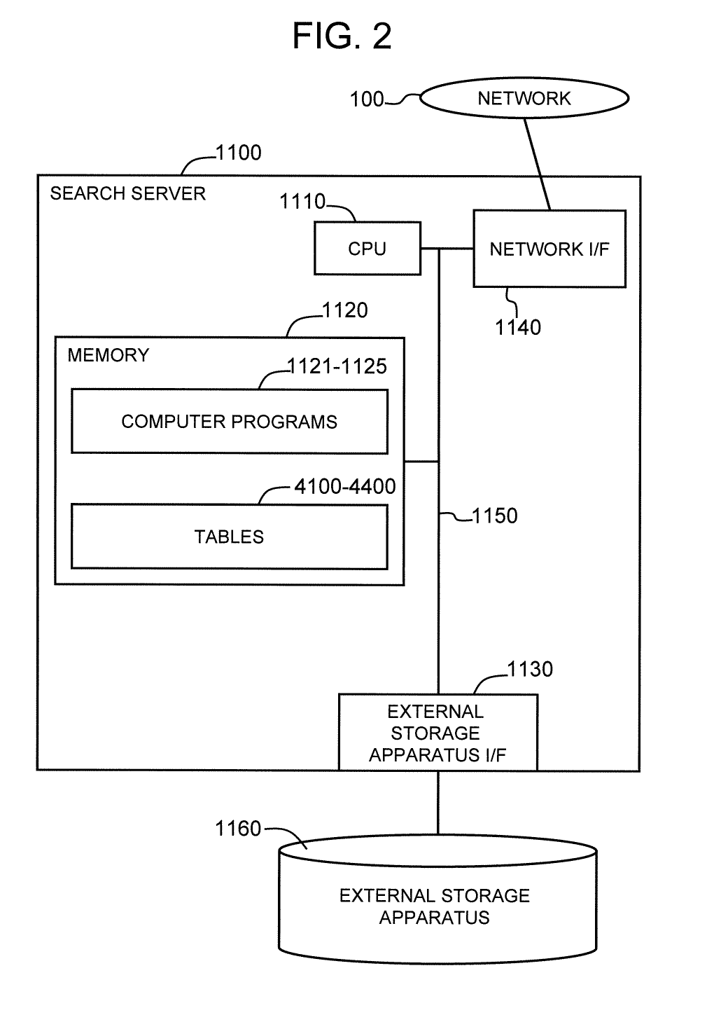

FIG. 2 is a schematic diagram showing an example of the hardware configuration of the search server 1100. In this example, of the three search servers 1100, 1200, 1300, the search server 1100 is the point of contact for an integrated search service. That is, the search server 1100 is an “integrated search server” for providing an integrated search service to the client machine, and, in addition, is also a “prescribed search server” that carries out a search in accordance with a search request.

The search server 1100, for example, comprises a processor 1110, a memory 1120, an external storage apparatus interface (hereinafter I/F) 1130, a network I/F 1140, and a bus 1150 for coupling these components 1110, 1120, 1130 1140.

The processor 1110 executes a computer program (hereinafter program). The memory 1120 stores programs 1121 through 1125 and tables 4100 though 4400, which will be described further below. The external storage I/F 1130 is a communication circuit for accessing an external storage apparatus 1160. The network I/F 1140 is a communication circuit for accessing the other apparatuses (the file server and the client machine) via the communication network 100.

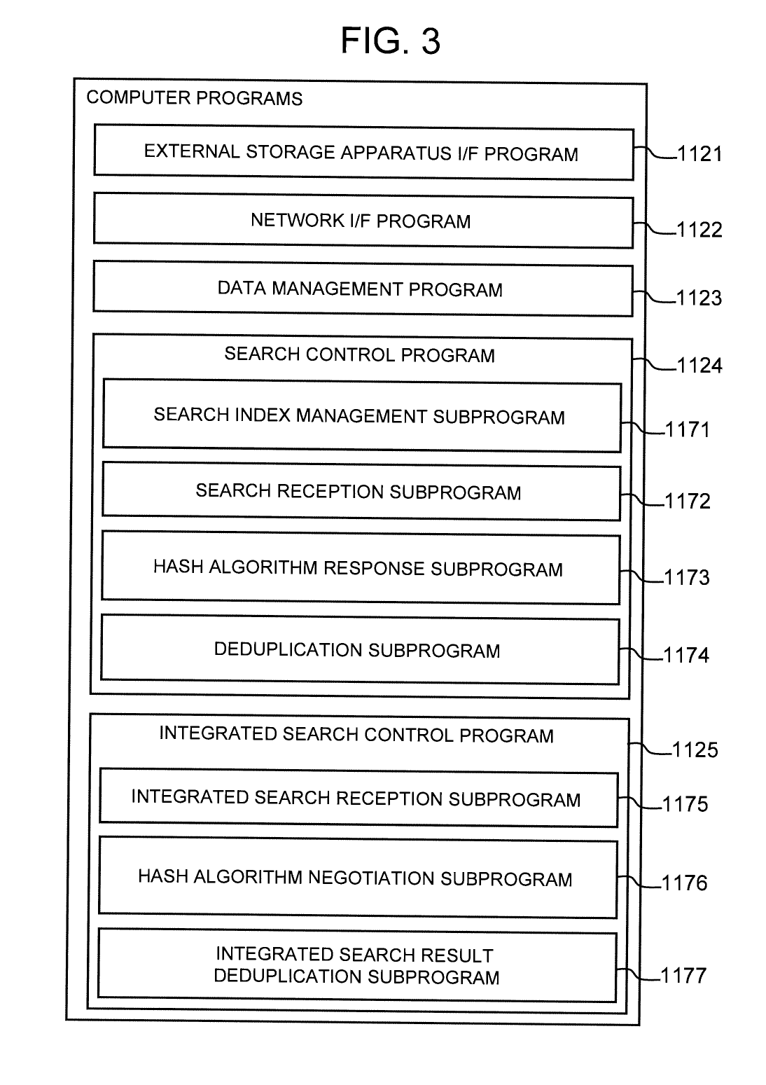

FIG. 3 shows the program content to be stored in the memory 1120. The memory 1120, for example, stores an external storage apparatus I/F program 1121, a network I/F program 1122, a data management program 1123, a search control program 1124, and an integrated search control program 1125.

The external storage apparatus I/F program 1121 controls the external storage apparatus I/F 1130. The network I/F program 1122 controls the network I/F 1140. The data management program 1123 provides either a file system or a database that is used for managing data maintained in the search server 1100. The search control program 1124 provides a search service in the search server 1100. The integrated search control program 1125 provides an integrated search service in the search server 1100.

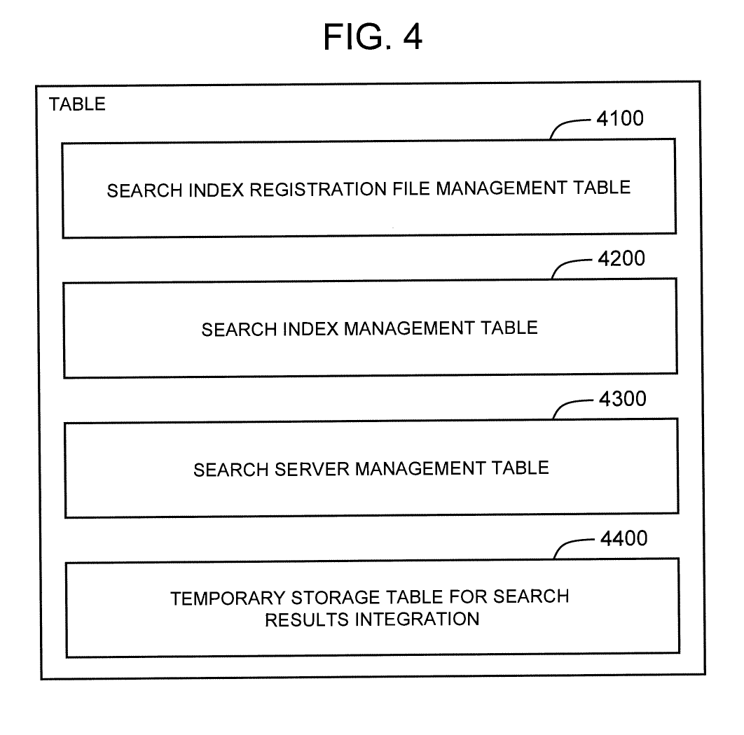

FIG. 4 shows the contents of a table (management data) stored in the memory 1120. The memory 1120, for example, stores a search index registration file management table 4100, a search index management table 4200, a search server management table 4300, and a temporary storage table for search results integration 4400.

The search index registration file management table 4100 is used by the search control program 1124, and manages a file that is registered in the search index. The search index management table 4200 manages the search index. The search server management table 4300 is used by the integrated search control program 1125, and manages each search server included in an integrated search system. The temporary storage table for search results integration 4400 is used by the integrated search control program 1125, and temporarily stores the results of an integrated search.

Return to FIG. 3. The search control program 1124 comprises a search index management subprogram 1171, a search reception subprogram 1172, a hash algorithm response subprogram 1173, and a deduplication subprogram 1174.

The search index management subprogram 1171 carries out processing required for managing search index data. Specifically, the search index management subprogram 1171 carries out a crawling process with respect to a file server 3100, which is storing file data that is the search target of the search server 1100, and creates, updates and deletes search index data as needed. The search index management subprogram 1171 uses the data management program 1123 to manage a search index data entity.

The search reception subprogram 1172 receives a search request that specifies a search query from a client machine. The search reception subprogram 1172 searches for a file that matches this search condition, and carries out a process for responding to the client machine with a search result. In this example, the search reception subprogram 1172 carries out a search process using search index data created separately by the search index management subprogram 1171.

The hash algorithm response subprogram 1173, in a case where a hash algorithm negotiation has been requested by another search server, receives this request and issues a response after having carried out the required processing. The hash algorithm response subprogram 1173 responds to the query source with a list of hash algorithms capable of being used by the search server in which the relevant hash algorithm response subprogram 1173 is loaded. The details will be explained further below, but a duplicate can be detected in an integrated search result by instructing each search server to use a hash algorithm capable of being used in common by the respective search servers.

Furthermore, in the following explanation, the search server, in which is loaded either a program or a table that is the subject of the sentence, may be called its own search server.

The deduplication subprogram 1174 carries out processing for detecting duplicate data in search index data that is being managed by the search index management subprogram 1171 of its own search server, and deleting the duplicate data as needed. That is, the deduplication subprogram 1174 eliminates duplicate data that is stored inside a single search server.

A hash algorithm, which will be described further below, is used to detect duplicate data. The deduplication subprogram 1174, based on a hash value that is computed using the hash algorithm, determines whether or not a certain arbitrary data inside the search index data is the same as another data.

The integrated search control program 1125 comprises an integrated search reception subprogram 1175, a hash algorithm negotiation subprogram 1176, and an integrated search result deduplication subprogram 1177.

The integrated search reception subprogram 1175, upon receiving an integrated search request specifying a search query from a client machine, uses other multiple search servers capable of an integrated search to search for a file that matches this search condition. The integrated search reception subprogram 1175 collects the search results from the respective search servers, and sends these search results to the client machine as an integrated search result. The integrated search reception subprogram 1175 uses the search server management table 4300 to select a search server that is capable of an integrated search.

The hash algorithm negotiation subprogram 1176, in a case where the integrated search reception subprogram 1175 has received an integrated search request, carries out processing required for negotiations and agreement with an integrated search-enabled search server group with respect to a hash algorithm to-be-used for eliminating duplicate content from inside an integrated search result. The specific contents of the processing will be explained further below.

The integrated search result deduplication subprogram 1177 carries out processing for detecting duplicate data inside search result data acquired from the integrated search-enabled search server group, and deleting this duplicate data as needed. The integrated search result deduplication subprogram 1177 uses the hash algorithm agreed upon with the other search servers in the group to detect the duplicate data. The integrated search result deduplication subprogram 1177 uses this hash algorithm to determine whether or not arbitrary data in the search result data is the same as other data.

The search index registration file management table 4100, the search index management table 4200, the search server management table 4300, and the temporary storage table for search results integration 4400 will be explained further below.

Except for the fact that they do not comprise a configuration related to an integrated search (the integrated search control program 1125, the search server management table 4300, and the temporary storage table for search results integration 4400), the other search servers 1200, 1300 have the same configuration as the search server 1100, and as such, explanations thereof will be omitted.

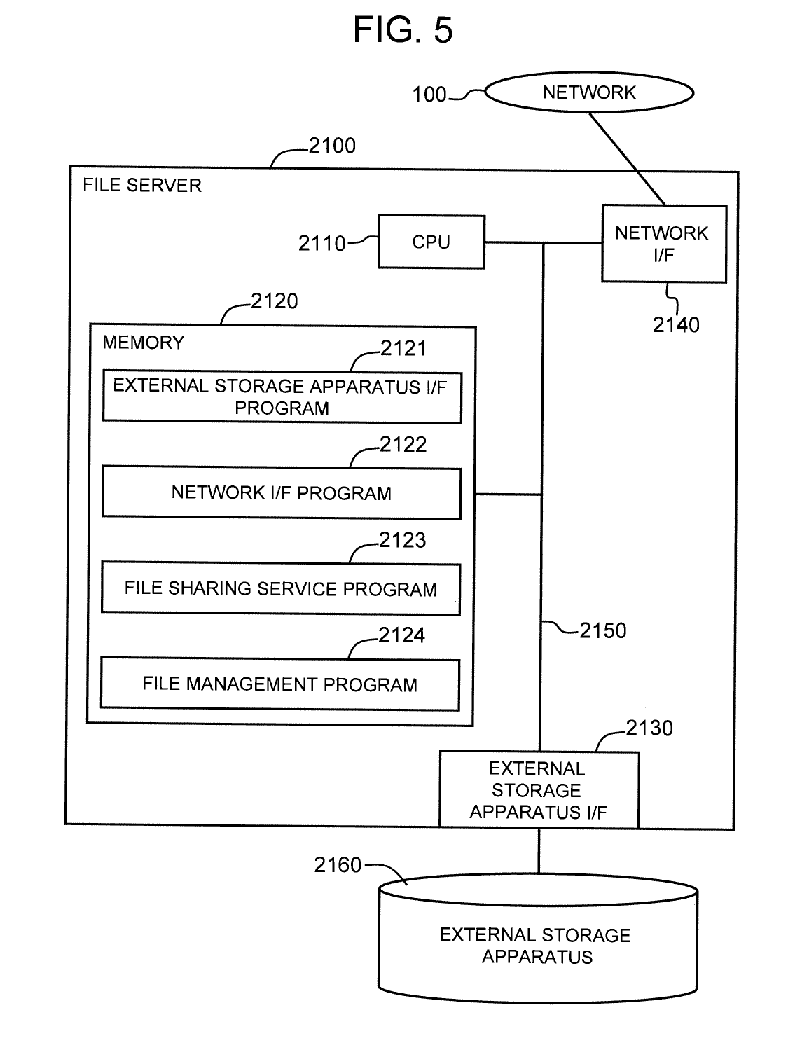

FIG. 5 is a schematic diagram showing an example of the hardware configuration of the file server 2100. The file server 2100, for example, comprises a processor 2110 for executing a program, a memory 2120 for temporarily storing a program and data, an external storage apparatus I/F 2130 for accessing an external storage apparatus 2160, a network I/F 2140 for communicating with other apparatuses (the search server and so forth) via the network 100, and a bus 2150 for coupling these components.

The memory 2120, for example, stores an external storage apparatus I/F program 2121, a network I/F program 2122, a file sharing service program 2123, and a file management program 2124.

The external storage apparatus I/F program 2121 controls the external storage apparatus I/F 2130. The network I/F program 2122 controls the network I/F 2140. The file sharing service program 2123 manages a file sharing service that is provided from the file server 2100. The file management program 2124 manages a file stored in the file server 2100.

The file sharing service program 2123 manages a shared file using the file management program 2124. Either a search server or a client machine can access a shared file that is stored in the file server 2100 by using the file sharing service program 2123.

Since the other file servers 2200, 2300 have the same configuration as the file server 2100 explained here, explanations thereof will be omitted.

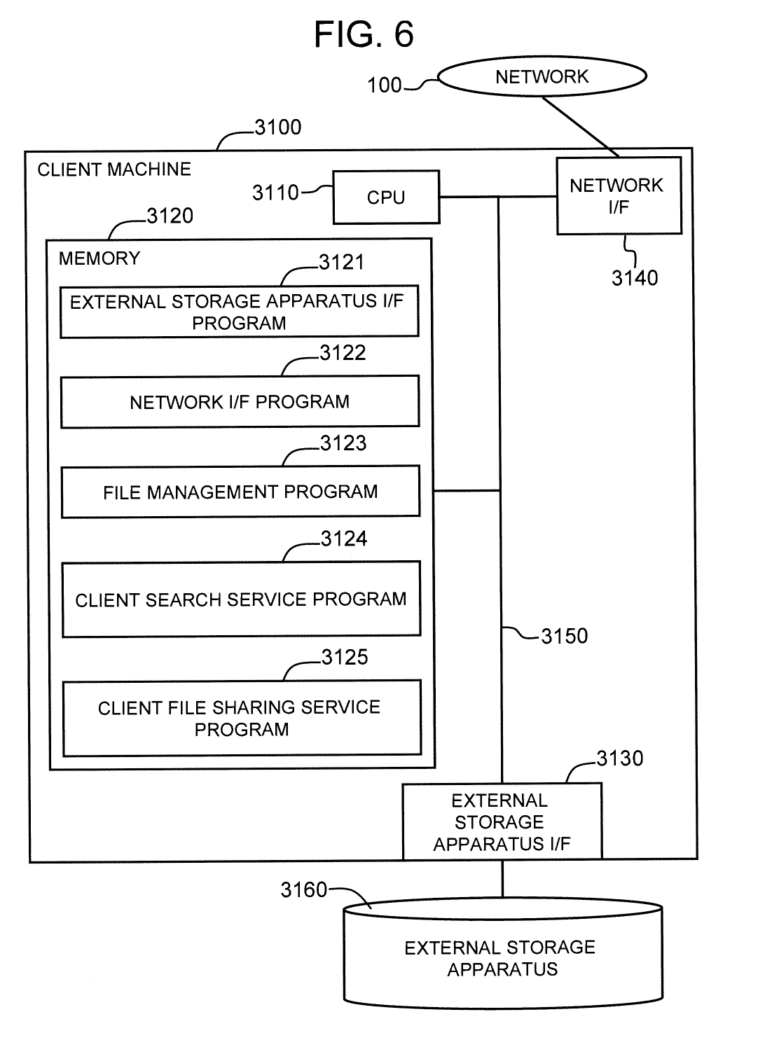

FIG. 6 is a schematic diagram showing an example of the hardware configuration of the client machine 3100. The client machine 3100, for example, comprises a processor 3110 for executing a program, a memory 3120 for temporarily storing a program and data, an external storage apparatus I/F 3130 for accessing an external storage apparatus 3160, a network I/F 3140 for accessing another apparatus coupled to the network, and a bus 3150 for coupling these components.

The memory 3120, for example, stores an external storage apparatus I/F program 3121, a network I/F program 3122, a file management program 3123, a client search service program 3124, and a client file sharing service program 3125.

The external storage apparatus I/F program 3121 controls the external storage apparatus I/F 3130. The network I/F program 3122 controls the network I/F 3140. The file management program 3123 provides a file system for managing a file stored in the client machine 3100. The client search service program 3124 is for using a search service and an integrated search service that are provided by the search server 1100. The client file sharing service program 3125 is for using a file sharing service that is provided by the file server 2100.

The client search service program 3124 uses an HTTP client program (for example, a Web browser or the like) in a case where a search service and an integrated search service utilize an HTTP protocol.

The client file sharing service program 3125 uses a NFS client program in a case where the file sharing service utilizes a NFS protocol. In a case where the file sharing service utilizes a CIFS protocol, the client file sharing service program 3125 uses a CIFS client program. Or, the client file sharing service program 3125 uses an HTTP client program (a Web browser or the like) in a case where a file sharing service utilizes an HTTP protocol.

Since the other client machines 3200, 3300 have the same configuration as the client machine 3100, explanations thereof will be omitted.

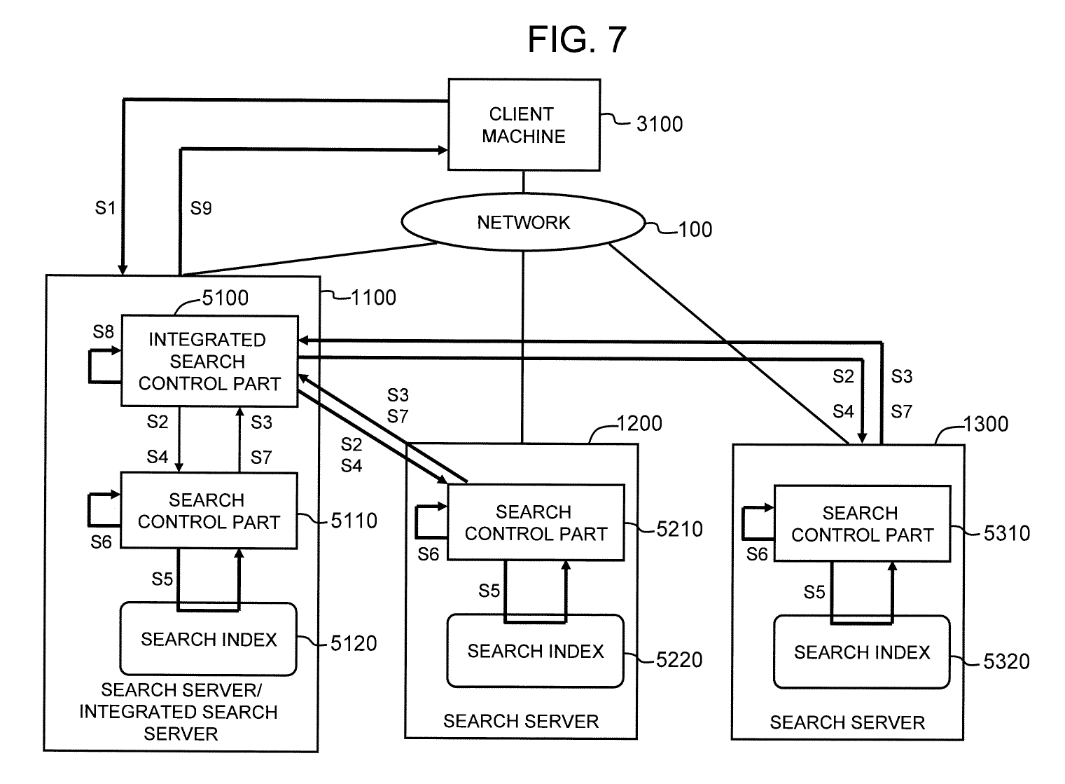

FIG. 7 schematically depicts the overall operation of the system in a case where an integrated search request has been issued from the client machine 3100 to the search server 1100. In FIG. 7, a series of processes, such as the issuing of an integrated search request, searches by respective search servers, the acquisition of search results from the respective search servers, and the provision of an integrated search result will be explained using nine steps. Hereinafter, step may be abbreviates as “S”.

Furthermore, the same reference sign 1100 will be appended to the search server 1100 that serves as the “integrated search server” for executing an integrated search process, and the search server 1100 that serves as the “prescribed search server” for searching in accordance with an integrated search request. For example, in a sentence such as “The search server 1100, which received the integrated search request, requests that each search server 1100, 1200, 1300 carry out a search.”, “The search server 1100, which received the integrated search request” is the integrated search server that receives the integrated search request and executes the integrated search process, and primarily corresponds to the integrated search control program 1125. The “search server 1100” in “each search server 1100, 1200, 1300” is the search server that carries out a specified search and returns a result, and primarily corresponds to the search control program 1124.

First, as S1, the client machine 3100 sends an integrated search request to the search server 1100 that provides the integrated search service. The integrated search request specifies a search keyword and a search condition.

The search keyword and the search condition used in the integrated search can be specified the same as the search keyword and search condition capable of being accepted by a conventional ordinary search engine. For example, multiple character strings may be specified as the search keyword. As the search condition, a data creation date or a data last update date may be specified using an arbitrary range, or a data creator may be specified.

As S2, an integrated search control part 5100 inside the search server 1100 that received the integrated search request carries out a hash algorithm (equivalent to identification information, such as a usable hash function) negotiation with respect to the search servers 1100, 1200, 1300 capable of being used in an integrated search. The integrated search control part 5100 is realized primarily by the integrated search control program 1125.

The search server 1100 that has received the integrated search request specifies a usable hash algorithm to its own search server 1100, and queries the other search servers 1200, 1300 as to whether the other search servers 1100, 1200, 1300 are able to use this hash algorithm.

As S3, search control parts 5110, 5210, 5310 inside the search servers 1100, 1200, 1300 that received the query respond to the integrated search control part 5100, which is the query source, with information as to whether or not the specified hash algorithm is supported and information regarding a usable hash algorithm other than the specified hash algorithm. The search control parts 5110, 5120, 5130 are realized by the hash algorithm response subprogram 1173.

The integrated search control part 5100 determines the hash algorithm capable of being used in the integrated search based on the response results from the search control parts 5110, 5210, 5310. In the following explanation, the hash algorithm capable of being used in the integrated search may be called the common hash algorithm. Furthermore, the configuration may be such that, in a case where the common hash algorithm cannot be determined by a single query, queries and responses will be repeatedly executed a prescribed number of times only.

As S4, the integrated search control part 5100 sends the same search request to search servers 1100, 1200, 1300, which are capable of being used in the integrated search. In addition to the search keyword and search condition included in the integrated search request, this search request may also comprise information related to the common hash algorithm that was determined in accordance with the above-described processing.

As S5, the search control parts 5110, 5210, 5310 each execute a search process using the search indexes 5120, 5220, 5320 managed in their own search servers 1100, 1200, 1300. The search keyword and the search condition specified by the integrated search control part 5100 are used in the search process.

As S6, the search control parts 5110, 5210, 5310 carry out a deduplication process with respect to each search result. Specifically, the search control parts 5110, 5210, 5310 each check whether or not multiple entries denoting the same file are registered among the entries included in the search results.

In a case where multiple entries denoting the same file are registered, the search control parts 5110, 5210, 5310, in accordance with a prescribed deduplication condition, only keep one arbitrary entry, and either do not display or delete the other entry(ies).

The hash algorithm is used to determine whether or not it is the same file. Specifically, a hash function or the like is used. The search control parts 5110, 5210, 5310 use the hash function to create a hash value for each file data or for multiple file data for which a determination is to be made as to whether or not the hash values are the same. In a case where the hash values match, it is possible to determine that these files are the same.

As S7, the search control parts 5110, 5210, 5310 respond to the integrated search control part 5100 of the search server 1100 that is the source of the search request with the search results from which duplicate entries in the search servers 1100, 1200, 1300 have been removed.

In addition to the search results, the search control parts 5110, 5210, 5310 also provide the integrated search control part 5100 with information that has been created using the common hash algorithm specified in S4. Specifically, the search control parts 5110, 5210, 5310 notify the integrated search control part 5100 of the hash value created using the hash function corresponding to the common hash algorithm.

As S8, the integrated search control part 5100 creates an integrated search result based on the search results acquired from each search server, and, in addition, carries out processing for eliminating a duplicate entry from the an integrated search result. Hereinafter, the processing to remove a duplicate entry from among the multiple entries included in the integrated search result may be called the integrated search result deduplication process.

The specific content of the integrated search result deduplication process is substantially the same as the content of the deduplication processes in each of the search control parts 5110, 5210, 5310 described above. Specifically, a check is made as to whether or not multiple entries depicting the same file data exist among the entries included in the integrated search result. In a case where multiple entries depicting the same file are registered in the integrated search result, only one arbitrary entry is kept and the other entries are either not displayed or deleted in accordance with a prescribed deduplication condition.

The hash algorithm is used to determine whether or not multiple file data are the same. Specifically, the hash values, which have been computed using the common hash algorithm and provided by the search servers, are used. In a case where multiple file data hash values (the hash value created inside the search server) match, a determination can be made that these file data are the same.

Lastly, as S9, the integrated search control part 5100 responds to the client machine 3100 with the duplicate entry-free integrated search result. In accordance with the above processing, the client machine 3100 is able to acquire the integrated search result.

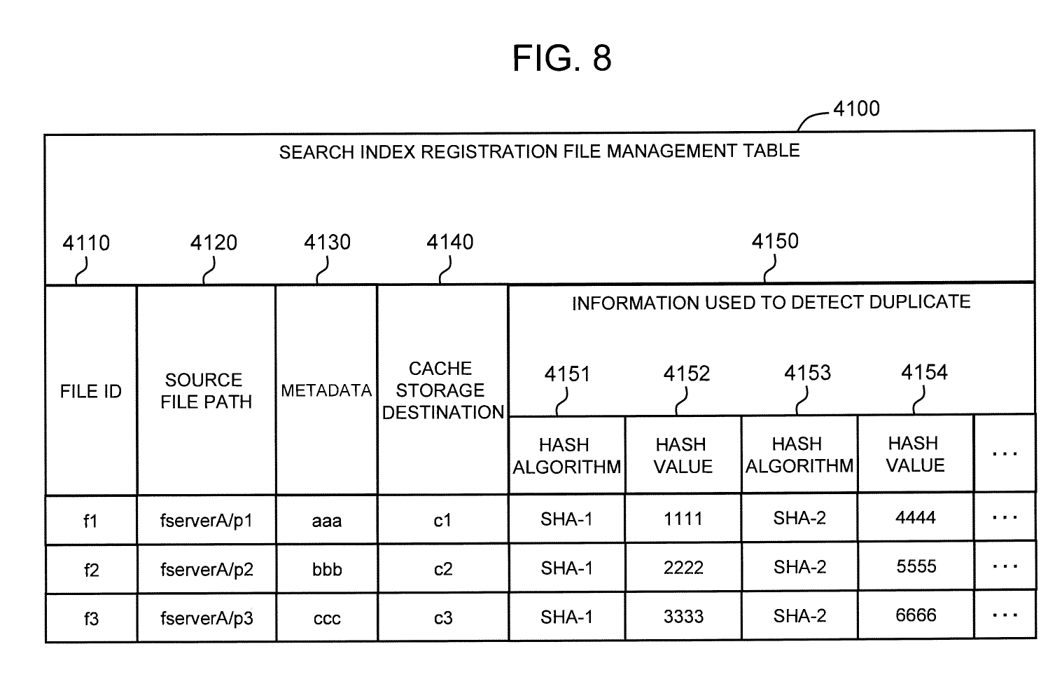

FIG. 8 shows an example of the configuration of the search index registration file management table 4100. The search index registration file management table 4100 manages information related to a file that a search server has acquired from a file server, which constitutes the search index creation target. Specifically, the search index registration file management table 4100 correspondingly manages a file ID 4110, a source file pathname 4120, target file metadata 4130, a cache storage destination 4140, and a target file hash algorithm (and hash value) 4150.

The file ID 4110 is an identifier for uniquely identifying a file that has been acquired from a file server. The file ID 4110 may be a serial number provided by the search server 1100, or may be a serial number provided by the file server 2100.

The source file pathname 4120 is a file pathname showing a storage destination in the file server of the target file. The search server specifies the source file pathname 4120 and issues a file get request to the file server. This makes it possible for the search server to get a desired file from the file server.

The target file metadata 4130 is a metadata aggregate associated with the target file. The metadata 4130, for example, is equivalent to information such as the file owner, the file creation date/time, the file size, and file access rights, which are managed by the file server. In addition, information such as the latest file access data/time managed by the search server can also be included in the metadata 4130.

The cache storage destination (storage location) 4140 is information denoting a storage location in a case where target file cache data is stored inside a search server. Specifically, in a case where the search server manages cache data in a file format, the file storage pathname is registered in the cache storage destination column 4140.

The target file hash algorithm and hash value column 4150 store information used for detecting a duplicate in the target file data. The column 4150 comprises columns 4151 and 4153 for registering hash algorithms, and columns 4152 and 4154 for registering hash values.

The hash algorithm columns 4151, 4153 register hash function identification information used for detecting a duplicate. Information for identifying a hash function, such as MD5 or SHA-1, for example, is registered in the hash algorithm columns 4151, 4153. Hash values created using the hash functions registered in the hash algorithm columns 4151, 4153 are registered in the hash value columns 4152, 4154.

The hash algorithm and hash value column 4150 is configured such that multiple sets of hash algorithms and hash values can be registered. FIG. 8 shows an example in which two sets each are registered for each file. Three or more sets may also be registered. In addition, the configuration may also be such that the same number of sets is registered for all the files, or the configuration may be such that the number of hash algorithm and hash value sets capable of being registered will differ for each file.

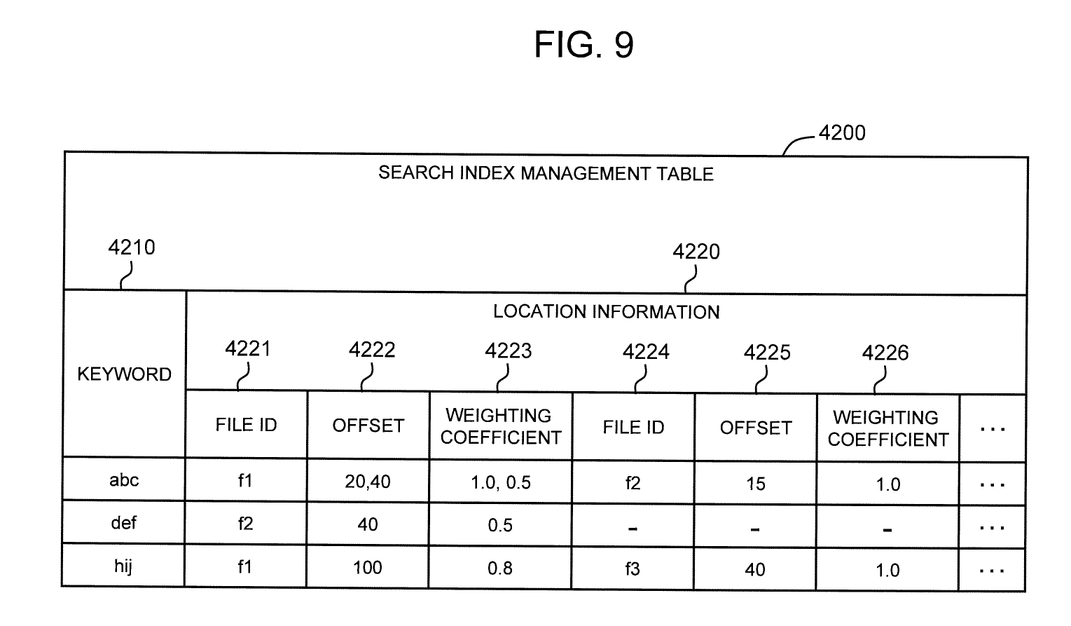

FIG. 9 shows an example of the configuration of the search index management table 4200. The search index management table 4200 manages information of a search index that has been created by a search server. Specifically, the search index management table 4200 correspondingly manages a keyword 4210 and location information 4220.

The keyword 4210 stores a character string obtained by indexing a target file. File information comprising the keyword 4210 character string is registered in the location information 4220. The location information 4220 includes file IDs 4221, 4224, relevant location offsets 4222, 4225, and weighting coefficients 4223, 4226.

The file IDs 4221, 4224 register information for identifying a file in which the keyword character string appears. The file IDs registered in the column of the file ID 4110 of the search index registration file management table 4100 are registered in the file IDs 4221, 4224.

The relevant location offsets 4222, 4225 register offset information where the keyword character string appears inside the file. Multiple pieces of offset information are registered in these columns 4222, 4225 in a case where the keyword string appears in multiple locations in a single file.

The weighting coefficients 4223, 4226 register the degree of importance with respect to the fact that the keyword character string appears inside the file. The search server can configure the degree of importance value as needed. A larger degree of importance value signifies greater importance. The degree of importance value can be used to narrow down search results and to align search results.

In the location information 4220, multiple registrations are possible with respect to a single keyword 4210. This makes it possible to handle a case in which there are multiple files corresponding to the keyword character string. Furthermore, it is also possible to register a null value in the location information 4220 to signify that the relevant entry value is invalid. In the drawing, the null value is denoted as “-”. The null value, for example, is used in an entry in which an item is blank due to the number of registrations being less than another entry.

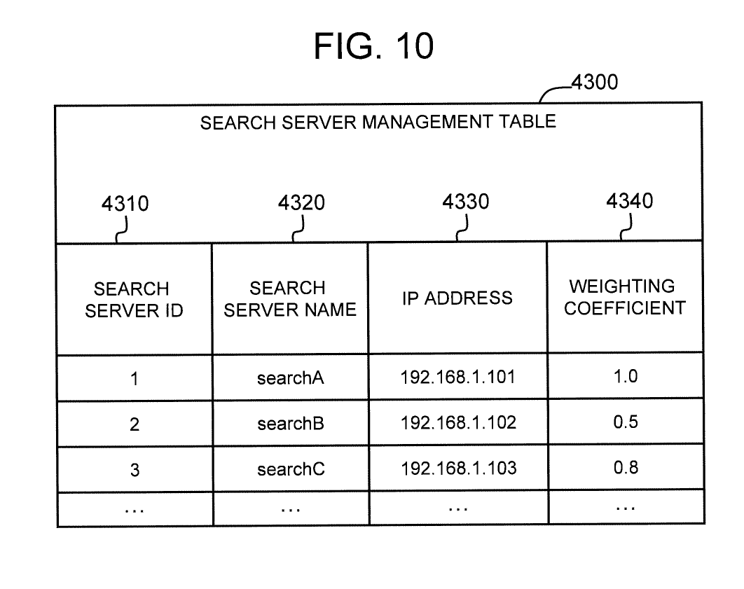

FIG. 10 shows an example of the configuration of the search server management table 4300. The search server management table 4300, in a case where a search server is to carry out an integrated search, manages a list of information with respect to the search servers that become the search request destinations. Specifically, the search server management table 4300 correspondingly manages a search server ID 4310, a search server name 4320, an IP address 4330, and a weighting coefficient 4340.

The search server ID 4310 stores an identification number for identifying a search server that is capable of being used in an integrated search. The search server ID 4310 may be a serial number that is provided by the search server 1100, which carries out the integrated search, or may be serial number that is provided inside the system, which provides the integrated search service.

The search server name 4320 stores the name of a search server. Specifically, the search server name 4320 may be a search server hostname, or may be a name comprising an arbitrary character string. The IP address 4330 stores the IP address provided to the search server. Furthermore, in the case of a system configuration in which DNS is used to determine the IP address, the hostname used in the DNS query may be stored in the IP address 4330 column.

The weighting coefficient 4340 stores a value denoting the degree of importance with respect to a search result obtained from the search server. The larger the value of the weighting coefficient, the greater the importance of the search result.

Priority can be given to a specific search server-generated search result inside the integrated search result by changing the value of the weighting coefficient 4340 for each search server. That is, the search result from a search server for which a large weighting coefficient has been configured can be displayed at the top of the integrated search result. The search result from a search server for which a small weighting coefficient has been configured is displayed lower in the ranking of the integrated search result. Furthermore, in a case where it is desirable to handle the search results obtained from all the search servers equally, the values of the weighting coefficient 4340 may be all be configured the same.

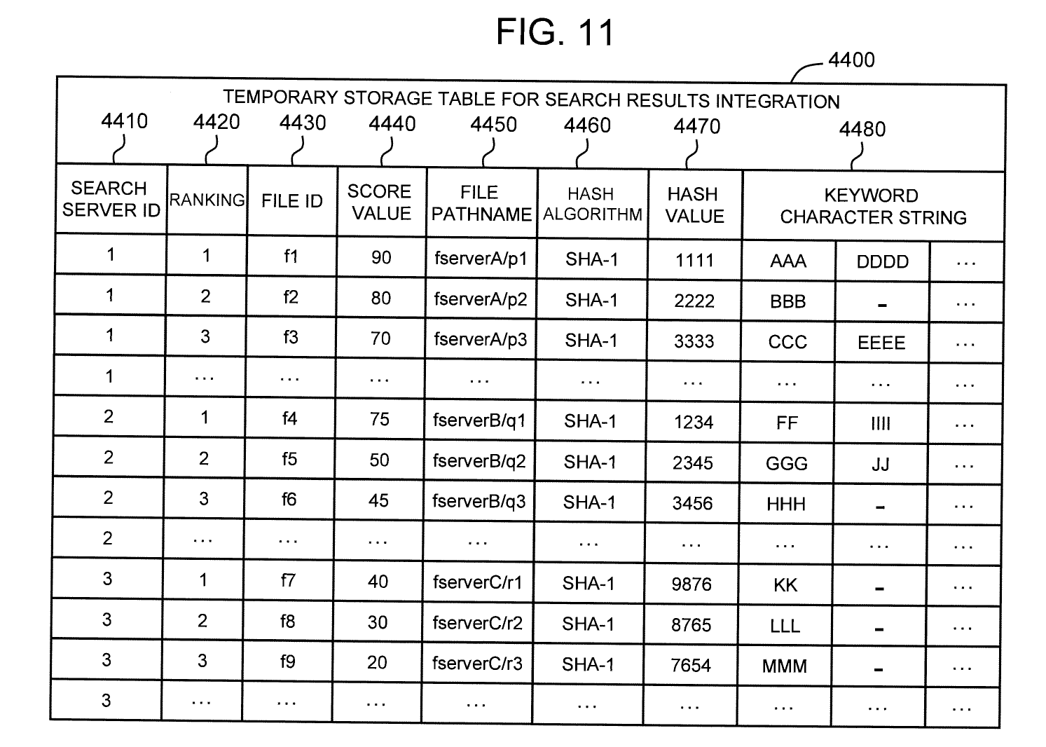

FIG. 11 shows an example of the configuration of the temporary storage table for search result integration 4400. The temporary storage table for search result integration 4400 is used for temporarily storing data with respect to a process that merges the search results from the respective search servers 1100, 1200, 1300 to create an integrated search result.

Specifically, the temporary storage table for search result integration 4400 correspondingly manages a search server ID 4410, a ranking 4420, a file ID 4430, a score value 4440, a file pathname 4450, a hash algorithm 4460, a hash value 4470, and a search keyword character string 4480.

The search server ID 4410 stores information for identifying a search server that has acquired a search result. The same information as that of the search server ID registered in the search server ID 4310 column of the search server management table 4300 is registered in the search server ID 4410.

The ranking 4420 stores as-is entry ranking information that has been sent from the search server. The ranking is a value, which arrays in descending order the levels of the search keywords and search conditions within the search results provided by the respective search servers and assigns ranks to this arrayed sequence.

The file ID 4430 stores as-is the file ID of the file corresponding to an entry sent from the search server. Specifically, the same information as the file ID registered in the file ID 4110 column of the search index registration file management table 4100 is registered in the file ID 4430.

The score value 4440 stores as-is entry score value information sent from the search server. The score value quantifies the levels of the search keywords and search conditions within the search results provided by the respective search servers. The weighting coefficient 4340 in the search server management table 4300 is multiplied by the score value to compute an integrated score value. The search server 1100 uses the integrated score value to determine an integrated ranking for the integrated search result.

The file pathname 4450 stores as-is the file pathname of the file corresponding to the entry sent from the search server. Specifically, the same information as the file pathname registered in the source file pathname 4120 column of the search index registration file management table 4100 is registered in the file pathname 4450.

Furthermore, identification information of the file server that stores the target file may be stored in the file pathname 4450 column in addition to the file pathname so as to enable access to the target file via the network 100.

The hash algorithm 4460 stores information for identifying a hash algorithm that is capable of being used by a search server. The hash value 4470 stores a hash value computed in accordance with the hash algorithm.

Furthermore, in a case where it was not possible to select a common hash algorithm in a negotiation process for determining the hash algorithm to-be-used in an integrated search (the common hash algorithm), null values signifying invalid values are stored in the column of the hash algorithm 4460 and the hash value 4470.

The search keyword character string 4480 stores as-is character strings that contain search keywords sent from the search server. The search keyword character string is an aggregate obtained by extracting character strings comprising search keywords from the respective files included in the search results from the respective search servers.

Including character string information comprising a search keyword in the search result makes it possible for the user to use a partial sentence or character string in which a specified search keyword is included as a portion of a search result. This makes it possible for the user to discern the context before and after the character string that includes the search keyword without actually accessing the target file cited in the search result. Therefore, the search keyword character string 4480 can enhance the convenience of the search service.

In a case where multiple locations comprising a search keyword exist in a single file, multiple search keyword character strings are also registered in the column 4480. The search server uses the information registered in the search index management table 4200 to create a search keyword character string. Furthermore, a null value signifying an invalid value is stored in a location of the search keyword character strings 4480 column that constitutes a blank due to the number of search keyword character strings provided from the search server being less than that of the other entries.

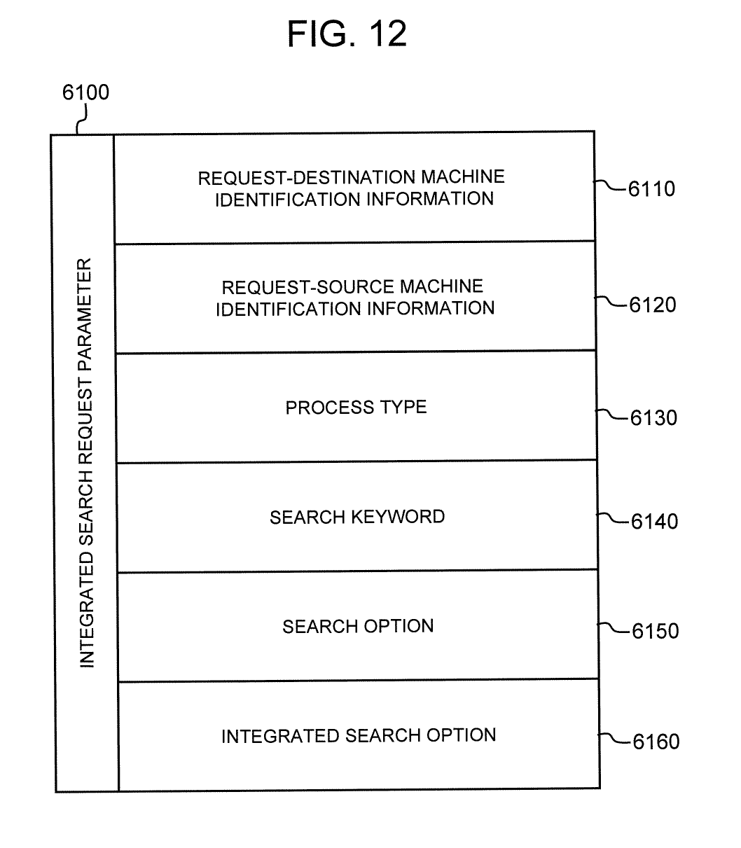

FIG. 12 shows an example of the configuration of an integrated search request parameter 6100 specified when an integrated search request is issued to the search server 1100 from the client machine. This parameter is used in S1, which was explained using FIG. 7. Specifically, the integrated search request parameter 6100 comprises request-destination machine identification information 6110, request-source machine identification information 6120, a process type 6130, a search keyword 6140, a search option 6150, and an integrated search option 6160.

The request-destination machine identification information 6110 stores information for identifying the search server, which will become the destination of an integrated search request. The request-destination machine identification information 6110 stores access information, such as a search server hostname or IP address for accessing the search server via the network 100.

The request-source machine identification information 6120 stores information for identifying the client machine that requested the integrated search. The request-source machine identification information 6120 stores access information, such as the client machine hostname or the client machine IP address for accessing the client machine via the network 100.

The process type 6130 stores information for identifying the content of a process. In a case where an integrated search request is to be issued, information denoting the integrated search request process is stored in the process type 6130. The search keyword 6140 stores a search keyword to be used in the integrated search request.

The search option 6150 stores information related to an option specifying when a request for a search is to be issued to the respective search servers. The search option 6150, for example, can specify a condition related to a file creation date/time, a file update date/time, and a file creator or the like.

The integrated search option 6160 stores information related to an option for specifying the search server 1100 to carry out the integrated search process. The integrated search option 6160, for example, can be the number of an integrated search result to be provided to the client machine, or a condition related to the offset value of the first entry of the integrated search result. Configuring an offset value, for example, makes it possible to either start the first entry from the ranking 1 or from the ranking 100.

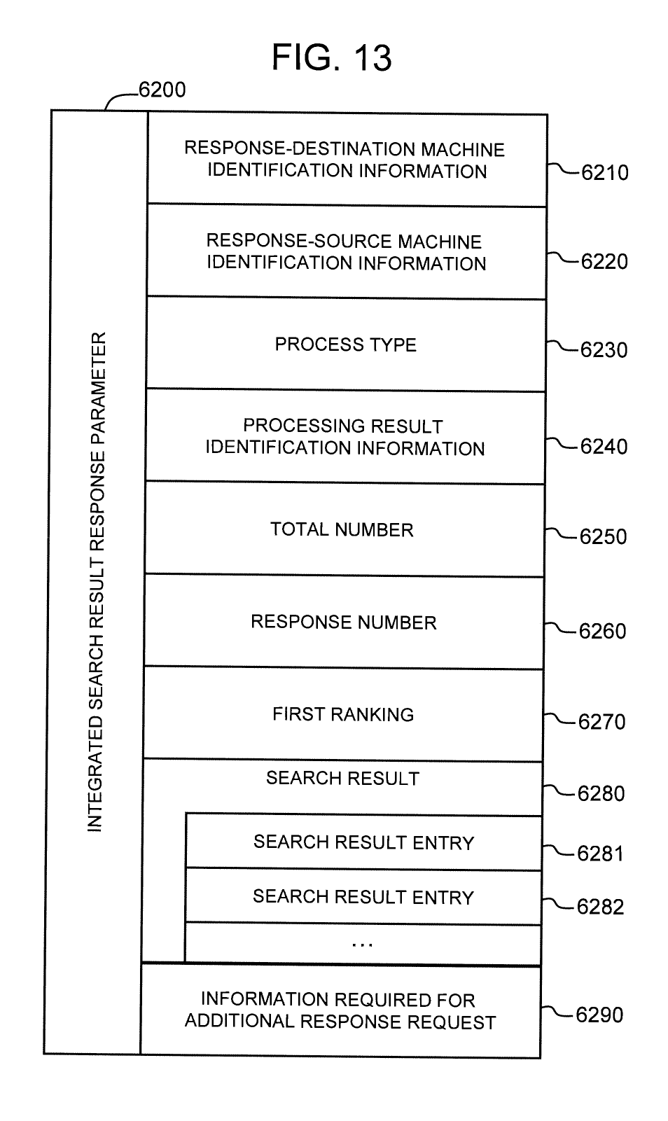

FIG. 13 shows an example of the configuration of an integrated search result response parameter 6200, which is specified when the search server 1100 is to respond to the client machine with an integrated search result. This parameter 6200 is used in S9, which was explained using FIG. 7. Specifically, the integrated search result response parameter 6200 comprises response-destination machine identification information 6210, response-source machine identification information 6220, a process type 6230, processing result identification information 6240, a total number 6250, a response number 6260, a first ranking 6270, a search result 6280, and information required for additional response request 6290.

The response-destination machine identification information 6210 stores information for identifying the client machine, which will become the integrated search result destination. For example, access information, such as the client machine hostname or IP address, is stored in order to access the client machine via the network 100.

The response-source machine identification information 6220 stores information for identifying the search server 1100 that issued the integrated search request. The same as described hereinabove, for example, the search server 1100 hostname and IP address are stored.

The process type 6230 stores information for identifying the content of a process. In a case where the results of an integrated search are to be sent, the process type 6230 stores information denoting the integrated search result response process. The processing result identification information 6240 stores information for identifying an integrated search processing result. Specifically, information as to whether processing succeeded or failed is stored.

The total number 6250 stores the total number of file data that match a specified condition. The response number 6260 stores the number of file data matching the specified condition that is included in the integrated search result response. In a case where the value of the total number 6250 is equal to or less than the upper limit value of the response number 6260, the total number 6250 and the response number 6260 are identical. However, in a case where the total number 6250 is greater than the above-mentioned upper limit value, the surplus portion, which is larger than the upper limit value of the response number 6260, is not included in the integrated search result response.

The first ranking 6270 stores the ranking value of the first entry included in the integrated search result response. In a case where the entry ranked No. 1 is first, 1 is stored in the first ranking 6270, and in a case where the entry ranked No. 100 is first, 100 is stored in the first ranking 6270.

The search result 6280 stores the integrated search result acquired via an integrated search process. Search result entries 6281, 6282 proportional to the number stipulated in the response number ranked 6260 are stored in the search result 6280. The same information as the information stored in the respective columns 4410 through 4480 of the temporary storage table for search results integration 4400 are stored in the search result entries 6281 and 6282.

The information required for additional response request 6290 is used when the value of the response number 6260 is smaller than the value of the total number 6250. Link information for acquiring information related to another search result not included in the integrated search result response is stored in the column of the information required for additional response request 6290.

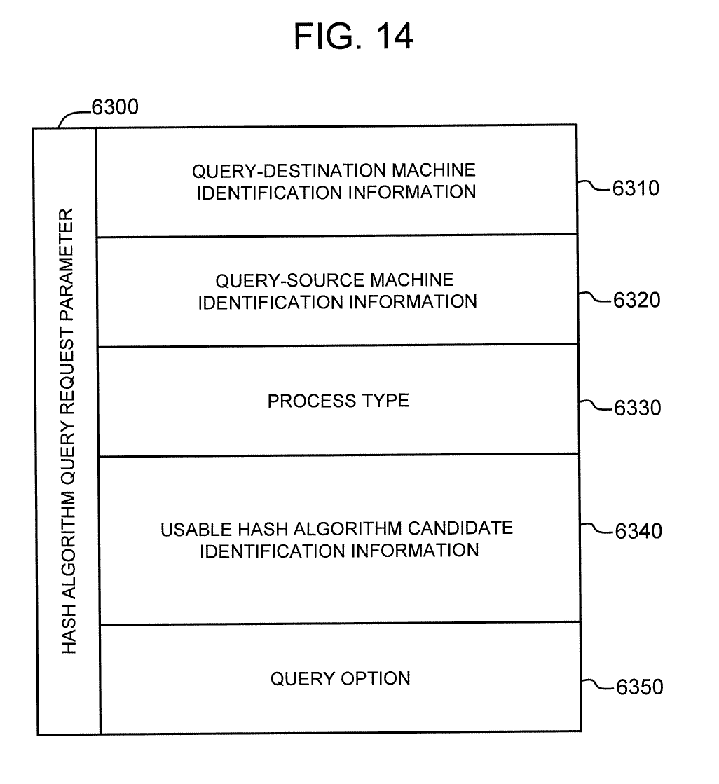

FIG. 14 shows an example of the configuration of a hash algorithm query request parameter 6300 to be specified in a query from the search server 1100, which has received an integrated search request, to the search servers 1100, 1200, 1300 that are capable of being used in an integrated search when carrying out a hash algorithm negotiation.

This parameter 6300 is used in S2, which was explained using FIG. 7. Specifically, the hash algorithm query request parameter 6300 comprises query-destination machine identification information 6310, query-source machine identification information 6320, a process type 6330, usable hash algorithm candidate identification information 6340, and a query option 6350.

The query-destination machine identification information 6310 stores information for identifying the search server, which will become the search request destination. That is, the query-destination machine identification information 6310 stores information for identifying the respective search servers, which are needed to negotiate the hash algorithm to-be-used prior to starting the integrated search. For example, access information, such as the search server hostname and IP address are stored for accessing the search server via the network 100.

The query-source machine identification information 6320 stores information for identifying the search server 1100 that will carry out the integrated search process. Access information, such as the search server 1100 hostname or IP address are stored in the query-source machine identification information 6320 for accessing the machine via the network 100.

The process type 6330 stores information for identifying the content of a process. In a case where a hash algorithm query is to be carried out, the process type 6330 stores information denoting a hash algorithm query request process.

The usable hash algorithm candidate identification information 6340 stores an identification information list of hash algorithms capable of being used in the search server 1100, which is the query source. In a case where a common hash algorithm can be used from among multiple hash algorithms stored in the hash algorithm candidate identification information 6340 in the respective search servers, this hash algorithm can be used to detect a duplicate included in the integrated search result.

The query option 6350 stores option information that can be specified in the hash algorithm query request process. Specifically, in a case where the condition for selecting a usable hash algorithm candidate is that the size of the hash value must be equal to or larger than a prescribed size, the lower limit value of the hash value size can be specified as an option.

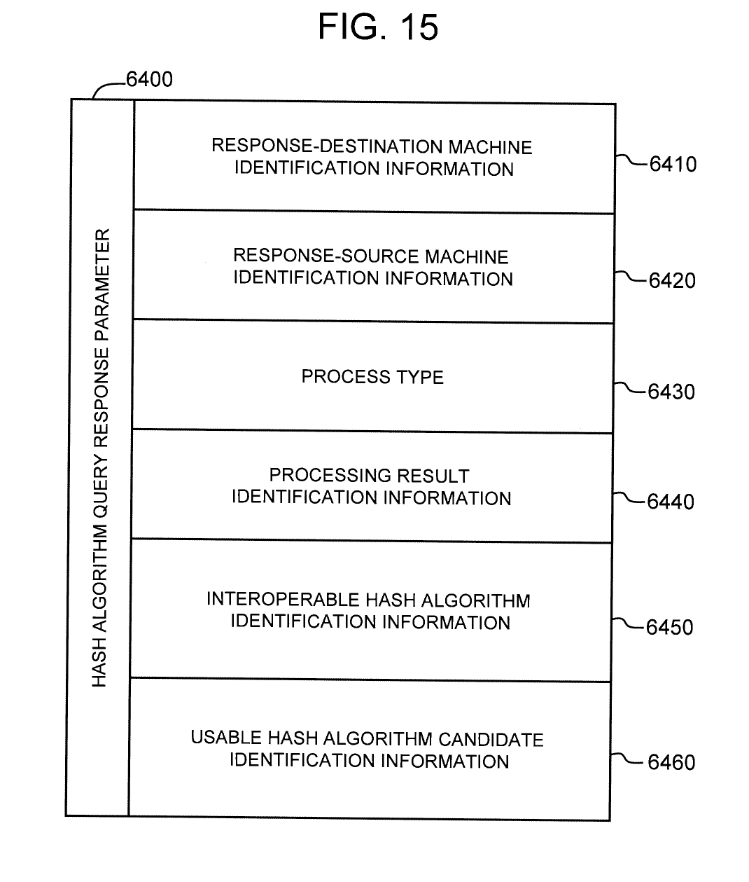

FIG. 15 shows an example of the configuration of a hash algorithm query response parameter 6400, which is used in a case where the respective search servers 1100, 1200, 1300 respond to the search server 1100, which is the hash algorithm query request source.

This parameter 6400 is used in S3, which was explained using FIG. 7. The hash algorithm query response parameter 6400 comprises response-destination machine identification information 6410, response-source machine identification information 6420, a process type 6430, processing result identification information 6440, interoperable hash algorithm identification information 6450, and usable hash algorithm candidate identification information 6460.

The response-destination machine identification information 6410 stores information for identifying the search server 1100 to which a response should be sent with respect to a query related to the hash algorithm. The same as mentioned above, access information, such as the search server 1100 hostname or IP address, is stored.

The response-source machine identification information 6420 stores information for identifying the respective search servers, which received the query with respect to the hash algorithm. The same as mentioned above, access information, such as the hostnames or IP addresses of the respective search servers, is stored.

The process type 6430 stores information for identifying the content of a process. The process type 6430 stores information denoting the fact that there is a response to a hash algorithm query. The processing result identification information 6440 stores information denoting the processing result with respect to a hash algorithm query. Specifically, the processing result identification information 6440 stores information as to whether the query process succeeded or failed.

The interoperable hash algorithm identification information 6450 stores information for identifying, from among multiple hash algorithms included in the usable hash algorithm candidate identification information 6340, a hash algorithm that is also capable of being used in the search server that received the query.

Since the hash algorithm, which is stored in the interoperable hash algorithm identification information 6450, can be used by both the query-source search server and the query-destination search server, it constitutes one candidate that is capable of being used in integrated results duplicate detection. Of the interoperable hash algorithms with respect to which replies were received from the respective search servers, the hash algorithm shared in common by all the search servers can be selected as the hash algorithm for eliminating a duplicate from the integrated search result.

The usable hash algorithm candidate identification information 6460, in a case where there is another usable hash algorithm in the search server, which received a hash algorithm query, stores information for identifying this hash algorithm. In a case where a search server, which is taking part in an integrated search, is able to use a hash algorithm other than the hash algorithm (the hash algorithm registered in column 6340 of FIG. 14) that is capable of being used by the search server 1100, which is in charge of the integrated search, this hash algorithm is registered in column 6460.

Furthermore, the hash algorithm identification information, which is stored in the interoperable hash algorithm identification information 6450, is not stored in this usable hash algorithm candidate identification information 6460.

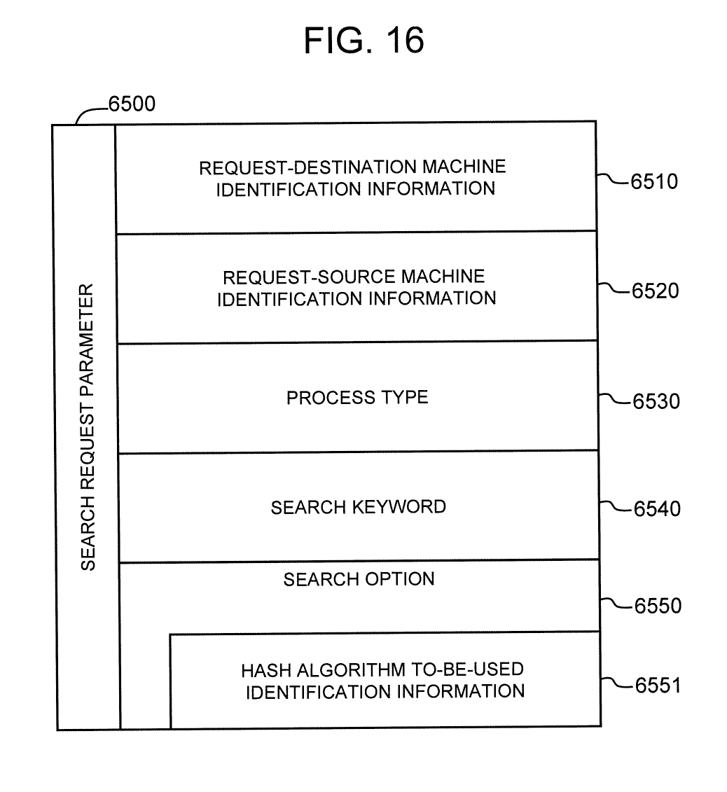

FIG. 16 shows an example of the configuration of a search request parameter 6500, which is specified when the search server 1100, which has received an integrated search request, issues a search request to the search servers 1100, 1200, 1300. This parameter 6500 is used in S4, which was explained using FIG. 7. The search request parameter 6500 comprises request-destination machine identification information 6510, request-source machine identification information 6520, a process type 6530, a search keyword 6540, and a search option 6550.

The request-destination machine identification information 6510 stores information (a hostname or an IP address) for identifying the search server, which will become the search request destination. The request-source machine identification information 6520 stores information (a hostname or an IP address) for identifying the search server 1100, which will issue the search request.

The process type 6530 stores information for identifying the content of a process. Here, the process type 6530 stores information denoting a search request process. The search keyword 6540 stores a search keyword to be used in a search. The search option 6550 stores specified option information related to the search. For example, the option information can specify a condition, such as a file creation date/time, a file update date/time, or a file creator.

In addition, the search option 6550 comprises hash algorithm to-be-used identification information 6551. In a case where a hash algorithm, which is shared in common among the related search servers, has been determined in accordance with the hash algorithm query process, the hash algorithm to-be-used identification information 6551 stores identification information with respect to this determined hash algorithm (the common hash algorithm).

The respective search servers use the hash algorithm specified by the hash algorithm to-be-used identification information 6551 to create a hash value and issue a response. Furthermore, the search server 1100, which received the integrated search request, detects and eliminates a duplicate entry from the integrated search result based on the hash value created using the common hash algorithm.

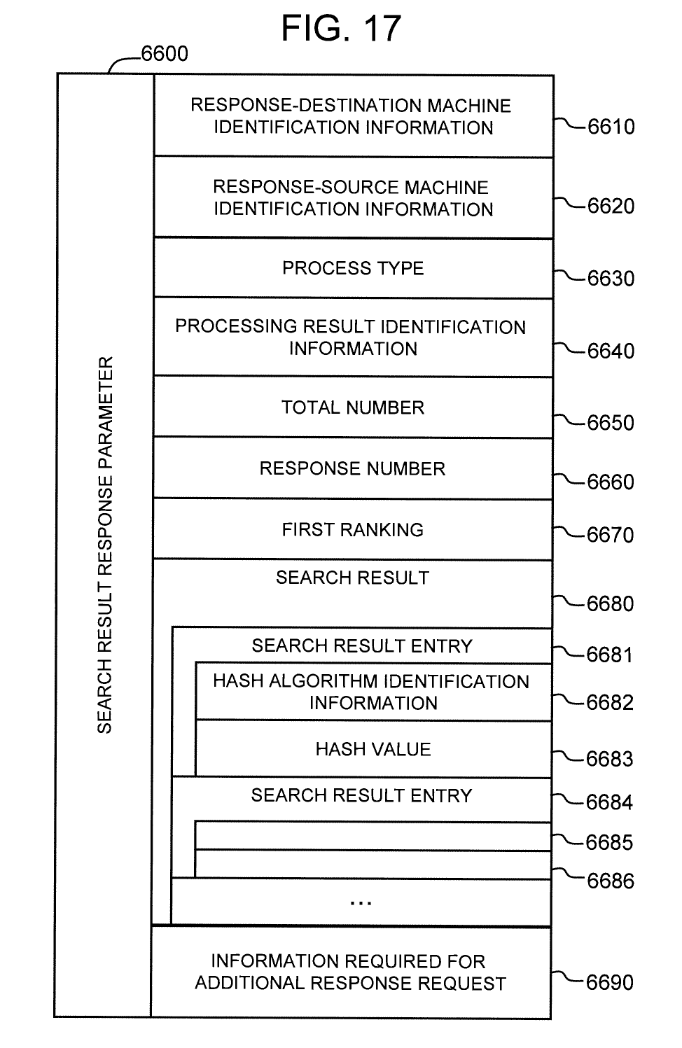

FIG. 17 shows an example of the configuration of a search result response parameter 6600 specified when the search servers 1100, 1200, 1300 respond with search results to the search server 1100 that carries out an integrated search. This parameter 6600 is used in S7, which was explained using FIG. 7. The search result response parameter 6600 comprises response-destination machine identification information 6610, response-source machine identification information 6620, a process type 6630, processing result identification information 6640, a total number 6650, a response number 6660, a first ranking 6670, a search result 6680, and information required for additional response request 6690.

The response-destination machine identification information 6610 stores information (a hostname or an IP address) for identifying the search server, which will become the search result destination. The response-source machine identification information 6620 stores information (a hostname or an IP address) for identifying the search server that received the search request.

The process type 6630 stores information for identifying the content of a process. Here, the process type 6630 stores information denoting a search result response process. The processing result identification information 6640 stores information that identifies a search processing result. More specifically, the processing result identification information 6640 stores information denoting whether the search was a success or a failure.

The total number 6650 stores the total number of files and data that match a specified condition. The response number 6660 stores the number of specified condition matching files and data that are included in the search results response. The same as was explained hereinabove, in a case where the total number 6650 is equal to or less than the upper limit value of the response number 6660, the total number 6650 and the response number 6660 are identical. In a case where the total number 6650 is greater than upper limit value of the response number 6660, the surplus portion that is larger than the upper limit value of the response number 6600 is not included in the search result response.

The first ranking 6670 stores a first entry ranking value with respect to an entry included in the integrated search result response. The same as was explained hereinabove, in a case where the No. 1 ranked entry is first, 1 is stored in the first ranking 6670. In a case where the No. 100 ranked entry is first, 100 is stored in the first ranking 6670.

The search result 6680 stores the search results acquired via a search process. Search result entries 6681, 6684 proportional to the number stipulated in the response number 6680 are stored in the search result 6680. The same information as the information stored in the respective columns 4410 through 4480 of the temporary storage table for search results integration 4400 are stored in the search result entries 6681 and 6684.

In addition, hash algorithm to-be-used identification information 6682 and 6685, and hash values 6683 and 6686 are also stored in the search result entries 6681 and 6684. The hash algorithm to-be-used identification information 6682 and 6685 stores as-is information specified in the hash algorithm to-be-used identification information 6551 of the search request parameter 6500.

Hash values, which were created using the hash algorithm (the common hash algorithm) identified by the hash algorithm to-be-used identification information 6682 and 6685, are stored in the hash values 6683 and 6686. The search server 1100, which has received an integrated search request, uses these hash values to detect and deduplicate entries from the integrated search result.

The information required for additional response request 6690 is used when the value of the response number 6660 is smaller than the value of the total number 6650. In this case, link information for acquiring information related to the search result of a file or data that has not been included in the search results response is stored in the column of the information required for additional response request 6690.

The preceding has been detailed explanations of the configuration of the search system, the configurations of the management information, and the configurations of the process parameters according to this example. Process operations according to this example will be explained hereinbelow. In the flowcharts referred to hereinbelow, loops will be omitted for ease of understanding. Therefore, the respective flowcharts shown in the drawings denote overviews of the respective processes, and will differ from the actual computer programs. A so-called person having ordinary skill in the art will be able to delete or change a step in a flowchart, or add a new step to a flowchart shown in the drawings. A flowchart, which has been modified in this way, will also be included within the scope of the present invention.

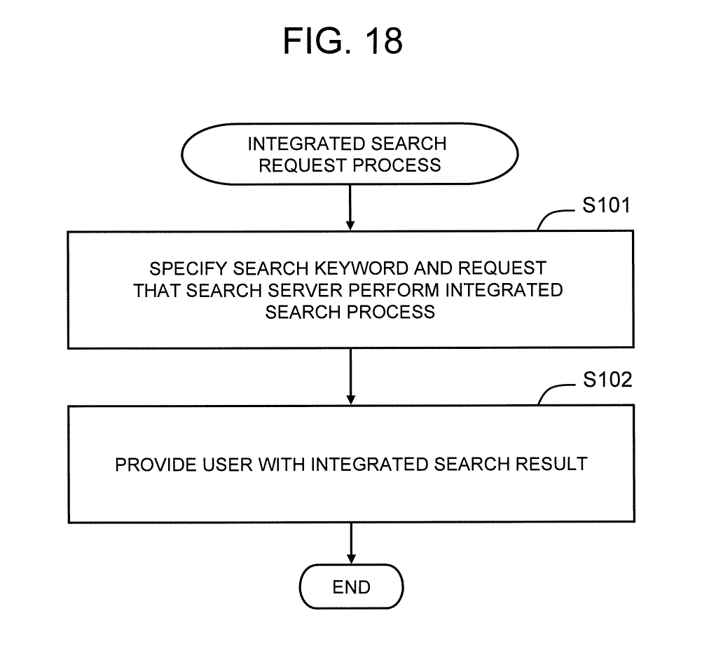

The flowchart of FIG. 18 shows an integrated search request process that is executed by any of the client machines. First, the client machine specifies a search keyword and requests that the search server 1100, which serves as the “integrated search server” that provides the integrated search service (S101), carry out an integrated search process. The client machine specifies the integrated search request parameter 6100 when requesting an integrated search. The client machine, after receiving the results of the integrated search from the search server 1100, which carries out the integrated search process, provides this integrated search result to the user (S102) and ends this processing. Furthermore, the integrated search result response parameter 6200 is used when acquiring the integrated search result response from the search server 1100.

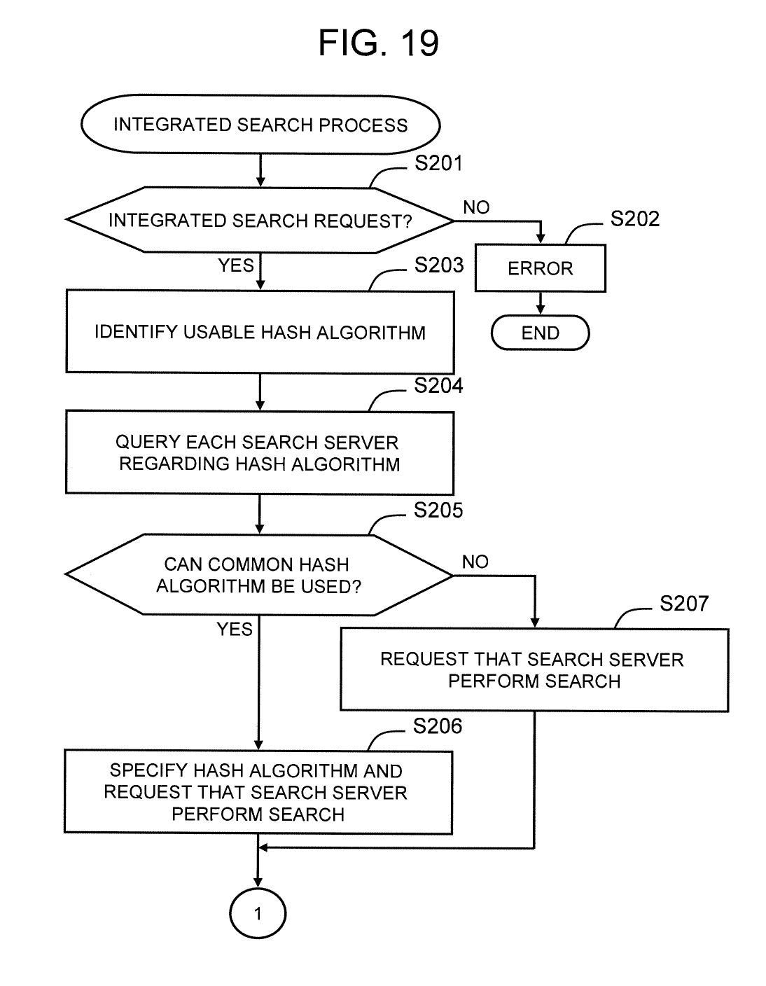

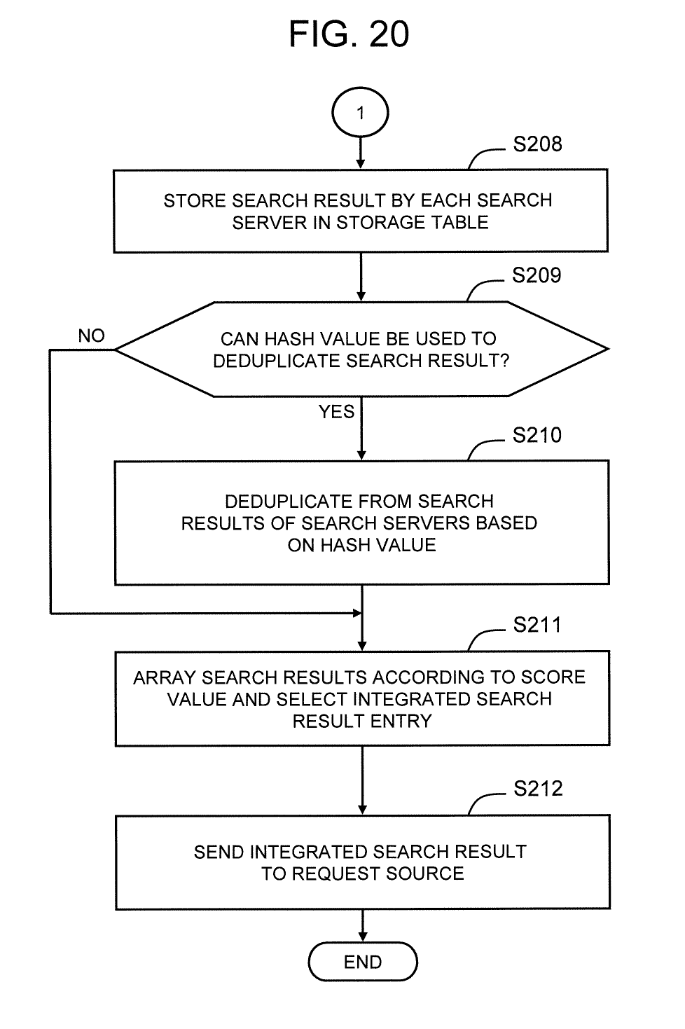

FIGS. 19 and 20 show flowcharts of the integrated search process that is executed by the search server 1100. First, the search server 1100, based on the process type 6130 of the integrated search request parameter 6100 received from the client machine, determines whether or not an integrated search request has been specified (S201). In a case where an integrated search request has not been specified (S201: NO), the processing ends in an error (S202).

In a case where an integrated search request has been specified (S201: YES), the search server 1100 identifies a hash algorithm capable of being used in the search server 1100 (S203). Specifically, a hash algorithm capable of being used by the search server 1100 can be identified by checking the hash algorithms 4151 and 4153 in the search index registration file management table 4100 managed by the search server 1100.

The search server 1100 queries the respective search servers registered in the search server management table 4300 as to a hash algorithm capable of being used by each search server (S204). The search server 1100 specifies the hash algorithm query request parameter 6300 at the time of this query.

The search server 1100 acquires the information included in the hash algorithm query response parameter 6400 from each search server. The search server 1100 determines whether or not it is possible to use a standardized hash algorithm (S205). The search server 1100, based on the response from each search server, determines whether or not a standardized usable hash algorithm exists in all the search servers that are to take part in the integrated search.

In a case where a standardized hash algorithm is able to be used (S205: YES), the search server 1100 specifies the hash algorithm to be used and requests that each search server taking part in the integrated search carry out a search (S206). The search server 1100 specifies the search request parameter 6500 when requesting a search. The search server 1100 respectively acquires the information included in the search result response parameter 6600 from each search server.

In a case where a standardized hash algorithm is unable to be used by the respective search servers taking part in the integrated search (S205: NO), the search server 1100 requests that each search server carry out a search without specifying a hash algorithm (S207). The search server 1100 specifies the search request parameter 6500 when requesting a search. The search server 1100 respectively acquires the information included in the search results response parameter 6600 from each search server.

Move to FIG. 20. After having acquired the search results, the search server 1100 stores the acquired search results in the temporary storage table for search results integration 4400 (S208). The search server 1100 determines whether or not it is possible to use a hash value to eliminate a duplicate entry from the integrated search result (S209).

In a case where it is not possible to eliminate a duplicate entry from the integrated search result (S209: NO), the search server 1100 skips S210 and proceeds to S211. In a case where it is possible to eliminate a duplicate entry from the integrated search result (S209: YES), the search server 1100 detects and eliminates a duplicate entry from the integrated search result using the hash value computed in accordance with the standardized hash algorithm (S210).

The search server 1100 uses the information registered in the temporary storage table for search results integration 4400 to array the search results in accordance with the score values or the like, and selects an entry for provision as an integrated search result to the integrated search query source (S211).

Specifically, the search server 1100 uses the score value 4440, which is registered in the temporary storage table for search results integration 4400, and the value of the weighting coefficient 4340, which is registered in the search server management table 4300, to compute an integrated score value. The search server 1100 uses this integrated score value to array the integrated search result entries.

Lastly, the search server 1100 responds with the integrated search result to the client machine, which is the integrated search request source (S212). The search server 1100 responds to the client machine with the integrated search result by specifying the integrated search result response parameter 6200.

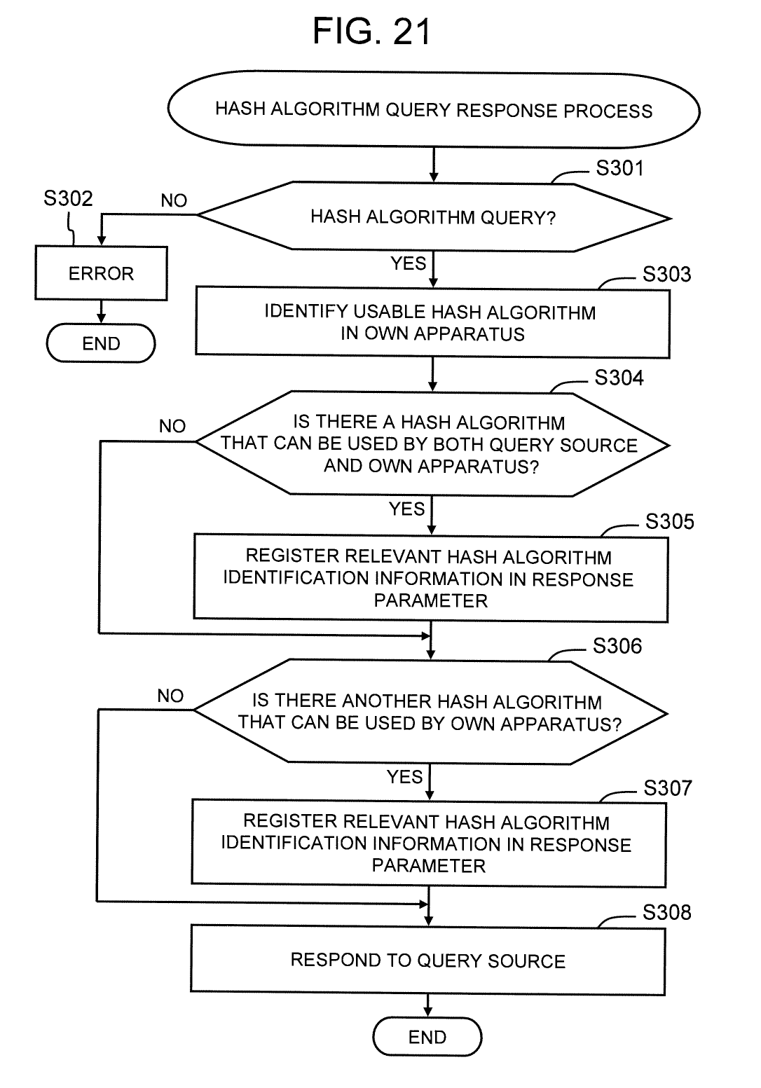

FIG. 21 is a flowchart of a response process with respect to a hash algorithm query executed by the respective search servers taking part in the integrated search. This process is respectively carried out by each search server 1100, 1200, 1300 serving as the “prescribed search server”. For the sake of convenience, an explanation will be given below by using the search server 1200 as an example.

First, the search server 1200, based on the process type 6330 specified in the hash algorithm query request parameter 6300, determines whether or not a “hash algorithm query request” has been specified (S301). In a case where a hash algorithm query request has not been specified (S301: NO), this processing ends in an error (S302).

In a case where a hash algorithm query request has been specified (S301: YES), the search server 1200 identifies a hash algorithm capable of being used in the search server 1200 (S303). The “own apparatus” in S303 is the search server 1200 here. The search server 1200 identifies a hash algorithm capable of being used in the search server 1200 by checking the hash algorithms 4151 and 4153 of the search index registration file management table 4100 managed by the search server 1200.

The search server 1200 determines whether or not there is a hash algorithm also capable of being used by the search server 1200 among the hash algorithms capable of being used by the query-source search server 1100 (S304). The search server 1200 compares the hash algorithms specified in the usable hash algorithm candidate identification information 6340 in the hash algorithm query request parameter 6300 to the hash algorithms capable of being used in the search server 1200 (S303), and checks whether or not a hash algorithm that is common to both exists.

In a case where a common hash algorithm exists (S304: YES), the search server 1200 registers the identification information of this hash algorithm in the interoperable hash algorithm identification information 6450 in the hash algorithm query response parameter 6400 (S305).

In a case where a common hash algorithm does not exist among the hash algorithms capable of being used in the query-source search server 1100 and the hash algorithms capable of being used in the query-destination search server 1200 (S304: NO), S305 is skipped and the processing proceeds to S306.

The search server 1200 determines whether or not there is another hash algorithm capable of being used in the search server 1200 besides the interoperable hash algorithm discovered in S304 (S306). The search server 1200 checks whether or not another hash algorithm, which was not a registration target in the processing of S305 exists among the hash algorithms identified in the processing of S303 as being hash algorithms that are capable of being used in the search server 1200.

In a case where another hash algorithm exists (S306: YES), the search server 1200 registers the identification information of this hash algorithm in the usable hash algorithm candidate identification information 6460 in the hash algorithm query response parameter 6400 (S307). In a case where another hash algorithm does not exist (S306: NO), S307 is skipped and the processing proceeds to S308.

The search server 1200 responds to the query-source search server 1100 with the hash algorithm query result (S308). The search server 1200 responds with the query result by specifying the hash algorithm query response parameter 6400.

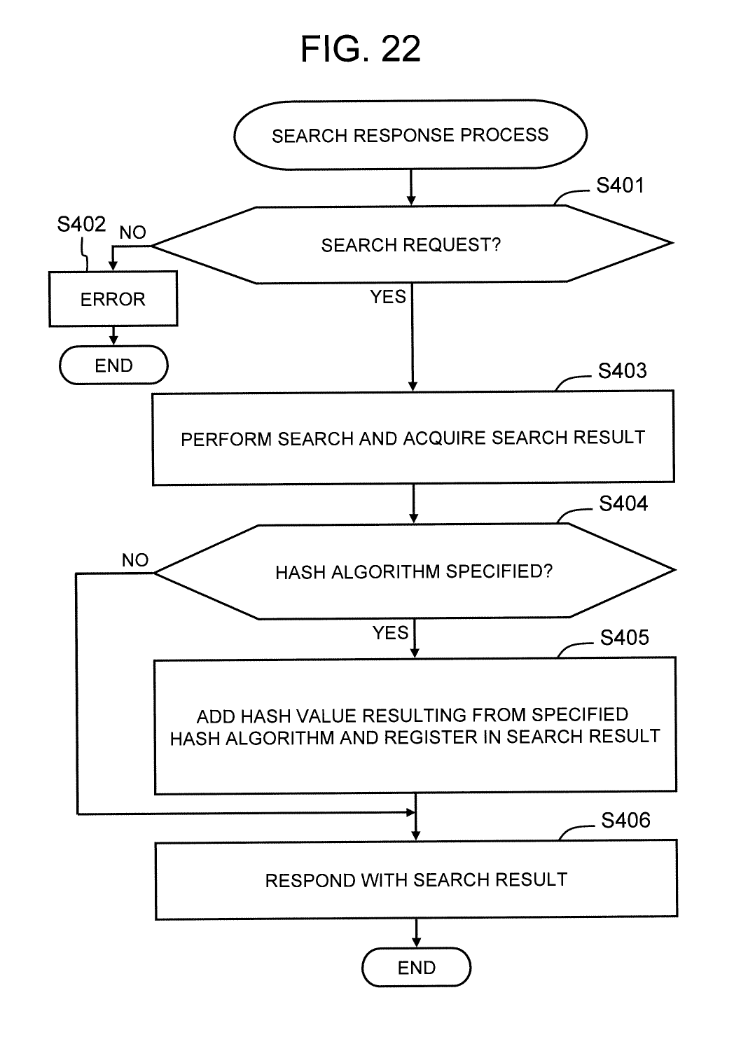

FIG. 22 shows a flowchart of a search response process executed by each search server. This process is respectively carried out by the search servers 1100, 1200, 1300 the same as the processing described using FIG. 21. For convenience sake, an explanation will be given here using the search server 1200 as an example.

First, the search server 1200 checks the process type 6530 specified in the search request parameter 6500, and identifies whether or not a “search request” has been specified (S401). In a case where a search request has not been specified (S401: NO), this processing ends in an error (S402). In a case where a search request has been specified (S401: YES), the search server 1200 executes a search process using the specified search keyword, and acquires the result of this search (S403). The search server 1200 uses the search keyword 6540 and the search option 6550 in the search request parameter 6500 to carry out the search process.

The search server 1200 checks whether or not the hash algorithm to-be-used identification information 6551 is specified in the search option 6550 of the search request parameter 6500 (S404). In a case where the hash algorithm to-be-used identification information 6551 is not specified (S404: NO), S405 is skipped and the processing proceeds to S406.

In a case where the hash algorithm to-be-used identification information 6551 is specified (S404: YES), the search server 1200 additionally registers the hash values of files included in each entry and the hash algorithm identification information used to create the hash values in each entry of the acquired search results (S405). The search server 1200 acquires the hash values and hash algorithm identification information based on the information stored in the file hash algorithm 4150 registered in the search index registration file management table 4100.

The search server 1200 responds to the request-source search server 1100 with the search results (S406). The search server 1200 responds with the search results by specifying the search results response parameter 6600.

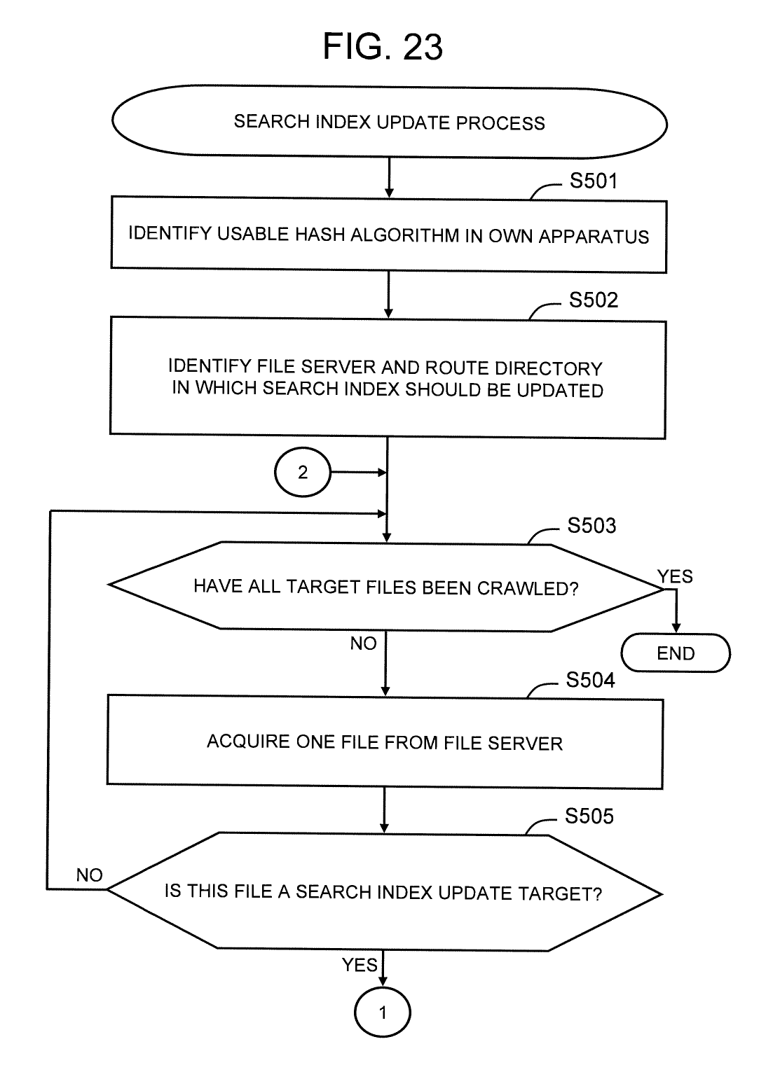

FIG. 23 shows a flowchart of a search index update process. This process is respectively carried out by each search server 1100, 1200, 1300. For the sake of convenience, an explanation will be given below using the search server 1200 as an example.

First, the search server 1200 identifies a hash algorithm capable of being used in the search server 1200 (S501). The “own apparatus” in S501 is the search server 1200 here. The search server 1200 identifies the hash algorithm capable of being used in the search server 1200 by checking the hash algorithms 4151 and 4153 in the search index registration file management table 4100 managed by the search server 1200.

The search server 1200 identifies the file server, which is the search index update target, and the root directory of the update target (S502). Next, the search server 1200 determines whether or not all of the search index update target files have been crawled and indexing completed (S503). In a case where crawling has been completed for all of the files (S503: YES), this processing ends.

In a case where the crawling and indexing processes have not been completed for all the files (S503: NO), the search server 1200 accesses the file server in which the crawling-target files are being stored, and acquires one arbitrary file stored in the search index update-target range (S504).

The search server 1200 determines whether information related to the file acquired in S504 needs to be registered anew in the search index, or whether the information related to the file acquired in S504 needs to be updated in the search index (S505).

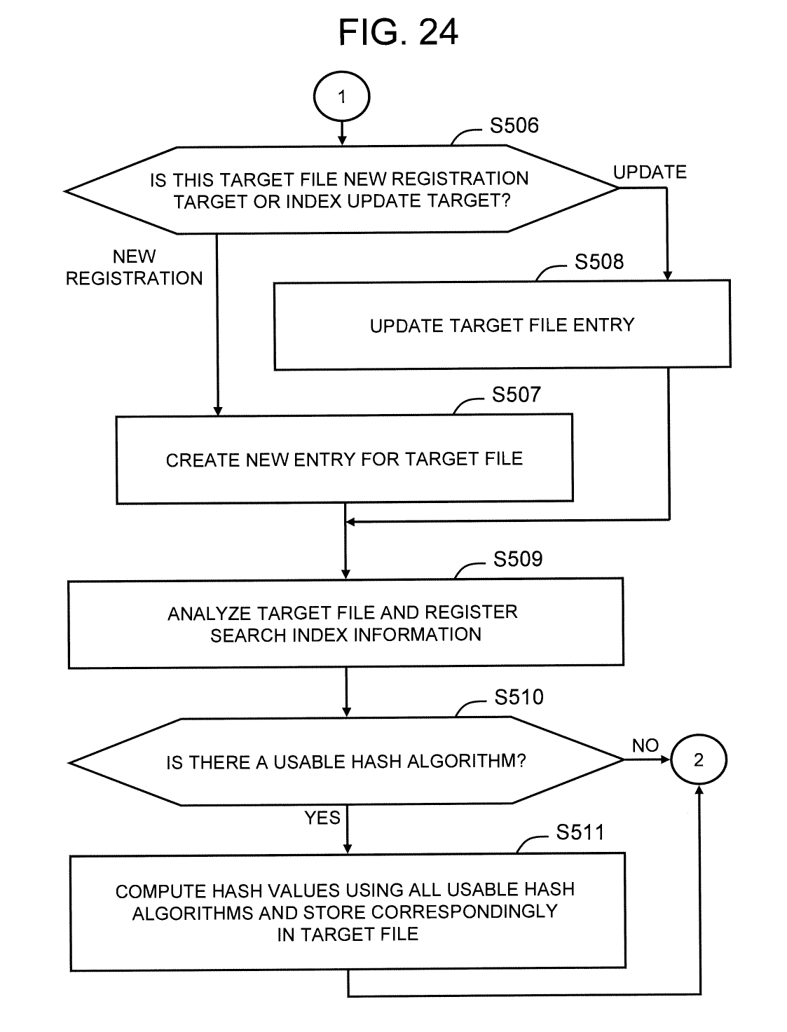

Specifically, the search server 1200 carries out a check from the standpoint of whether or not the acquired file has been updated since the time of the previous search index update process, or whether or not the acquired file was newly stored subsequent to the time of the previous search index update process. In a case where a new registration or update is not necessary (S505: NO), the processing returns to S503. In a case where a new registration or an update is required (S505: YES), the processing proceeds to S506 shown in FIG. 24. The search server 1200 determines whether the information of the file (the target file) acquired in S504 will be newly registered in the search index, or whether registered information will be updated in the search index (S506).

In a case where the determination is to carry out a new registration, the search server 1200 creates a new target file entry in the search index registration file management table 4100 and registers the target file information (S507).

In a case where the determination is to carry out an update, the search server 1200 identifies the target file entry stored in the search index registration file management table 4100 and updates the required information (S508). The search server 1200 analyzes the target file and registers the search index information in the search index management table 4200 (S509). The search server 1200 confirms whether or not a usable hash algorithm exists (S510). The search server 1200, based on the identification result of S501, determines whether or not one or more hash algorithms capable of being used in the search server 1200 exist. In a case where no usable hash algorithms exist (S510: NO), the processing returns to S503.

In a case where an usable hash algorithm exists (S510: YES), the search server 1200 uses all of the usable hash algorithms to create respective hash values from the target file data, and registers the created hash values in the search index registration file management table 4100 (S511).

In a case where there are multiple usable hash algorithms, the search server 1200 creates hash values corresponding to all of these hash algorithms, and registers these hash values in the search index registration file management table 4100.

In this example, which is configured as described hereinabove, in a case where an integrated search is carried out in a system in which multiple search servers each having different search algorithms and/or search index update times are loosely coupled, a hash algorithm that is used in common in each search server is determined.

Therefore, in this example, it is possible to detect and eliminate a duplicate entry from among the integrated search result which is obtained by integrating the search results from each search server related to the same search condition. In accordance with this, the user is able to readily obtain an integrated search result spanning multiple search servers. The user is able to use the integrated result from which a duplicate entry has been removed to relatively easily discover a target file, thereby enhancing usability.

In this example, of the loosely coupled multiple search servers 1100, 1200, 1300, the search server 1100, which receives the integrated search request, determines a hash algorithm that is used in common among the respective search servers 1100, 1200, 1300 by negotiating with each search server 1100, 1200, 1300, and the actual searches are respectively carried out by each search server 1100, 1200, 1300. In addition, in this example, each search server 1100, 1200, 1300 creates a hash value using the determined hash algorithm, and the search server 1100, which received the integrated search request, uses the hash value to detect a duplicate entry in the integrated search result and to remove this duplicate entry. In this example, a distinction is made between hash value creation and the detection and elimination of a duplicate using the hash value. In accordance with this, in this example, it is possible to divide up responsibility among multiple loosely coupled search servers.

### Example 2

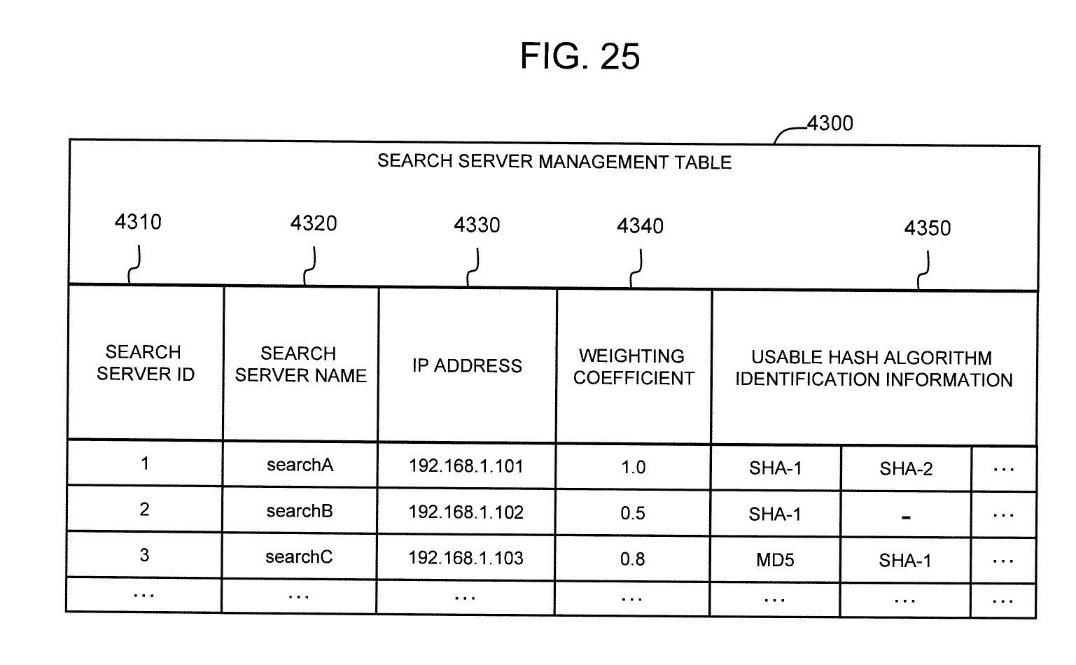

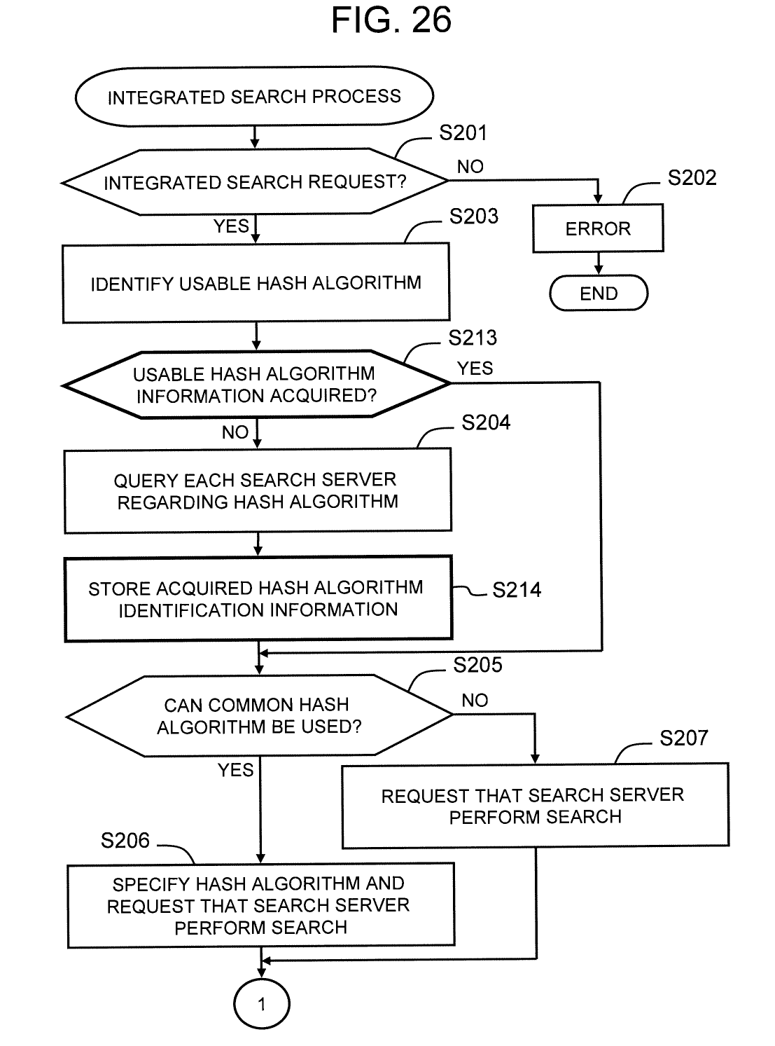

A second example will be explained by referring to FIGS. 25 and 26. Each of the following examples, to include this example, is equivalent to a variation of the first example. Therefore, in the examples that follow, the explanations will focus on the differences with the first example.

In the first example described hereinabove, negotiations are carried out between a search server 1100, which received an integrated search request, and the other search servers 1100, 1200, 1300 with respect to a hash algorithm to be used for eliminating a duplicate entry from the integrated search result each time an integrated search process is carried out.

However, the hash algorithm used in common among the respective search servers 1100, 1200, 1300 does not change very often. Under normal circumstances, it is believed that after being determined, the same hash algorithm is used for a relatively long time.

Consequently, in this example, the information of the initially acquired hash algorithm is stored as a cache inside the search server 1100 that received the integrated search request. Thereafter, in a case where an integrated search request has been issued, the information of the cached hash algorithm is used to determine the common hash algorithm and execute the integrated search process. Therefore, in this example, there is no need for the respective search servers to carry out negotiations with respect to the hash algorithm each time an integrated search request is received, thereby making it possible to reduce overhead when an integrated search is started.

In order to cache either one or multiple hash algorithms respectively acquired from each search server 1100, 1200, 1300 inside the search server 1100, it is necessary to change the configuration of the search server management table 4300 of the search server 1100, and, in addition, to change a portion of the integrated search process executed by the search server 1100.

FIG. 25 is an example of the configuration of the search server management table 4300 used in this example. In addition to the respective columns 4310, 4320, 4330 and 4340 described using FIG. 10, a column for managing usable hash algorithm identification information 4350 is added to the search server management table 4300.

The usable hash algorithm identification information 4350 stores information for the search servers 1100, 1200, 1300 taking part in the integrated search to respectively identify usable hash algorithms. Multiple hash algorithm identification information can be stored for a single search server. For example, in FIG. 25, SHA-1 and SHA-2 are stored as the usable hash algorithm identification information 4350 with respect to the search server ID 4310 entry of number 1. In the integrated search process, the identification information of a usable hash algorithm is stored in the table 4300 based on the usable hash algorithm information acquired from each search server.

FIG. 26 shows the content of the changes in the integrated search process executed by the search server 1100. This process differs from the integrated search process shown in FIG. 19 as follows. The first difference is that after S203 the search server 1100 makes a determination as to whether or not usable hash algorithm information exists in the search server management table 4300 (S213). The search server 1100 confirms whether or not hash algorithm identification information is registered in the usable hash algorithm identification information 4350 entry in the search server management table 4300.

In a case where usable hash algorithm information is stored in the search server management table 4300 (S213: YES), the search server 1100 omits the hash algorithm negotiation process S204 and moves to S205. In a case where usable hash algorithm information is not stored in the search server management table 4300 (S213: NO), the search server 1100 proceeds to S204 to carry out a hash algorithm negotiation process, similarly to the first example.

The second difference is that after S204 the search server 1100 registers the hash algorithm identification information acquired in S204 in the search server management table 4300 (S214). Specifically, the search server 1100 stores the hash algorithm identification information respectively acquired from the other search servers 1100, 1200, 1300 in the column of the usable hash algorithm identification information 4350. In a case where multiple hash algorithm identification information has been acquired with respect to a single search server, all of the hash algorithm identification information is registered in the search server management table 4300. After S214, the processing moves to S205.

Configuring this example like this also achieves the same effect as the first example. In addition, in this example, the hash algorithm identification information acquired at the time of the initial integrated search is held, a common hash algorithm is determined, and the integrated search is carried out. Therefore, there is no need to acquire information with respect to a hash algorithm from each search server 1100, 1200, 1300 each time an integrated search request is received, thereby making it possible to shorten integrated search overhead.

### Example 3

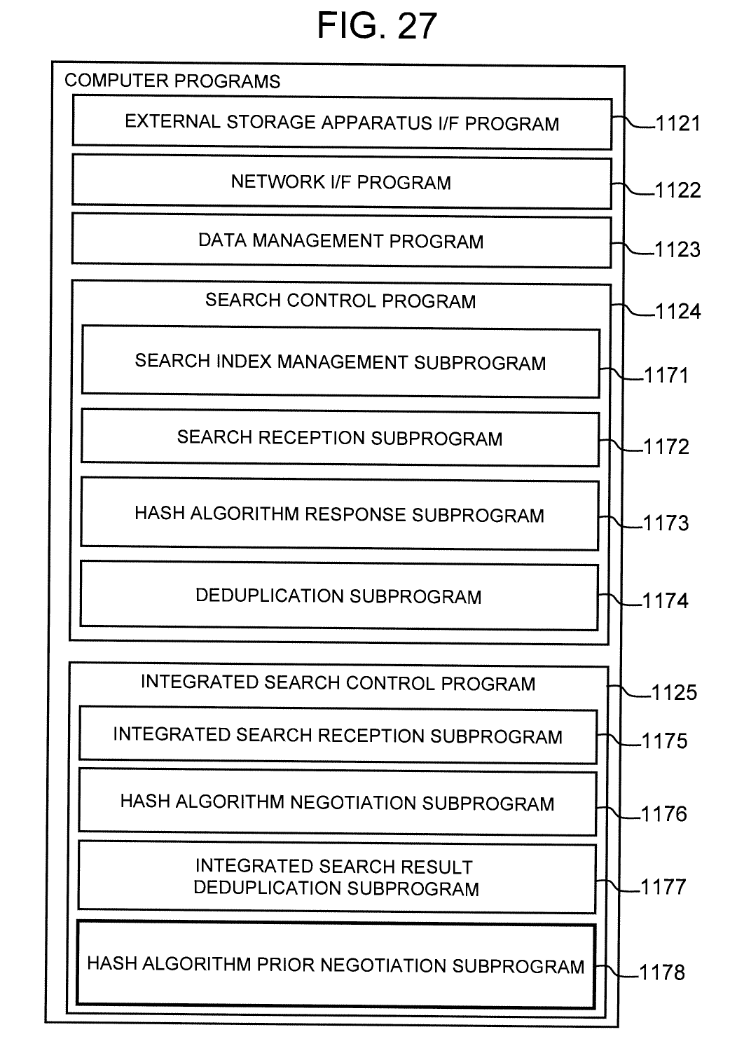

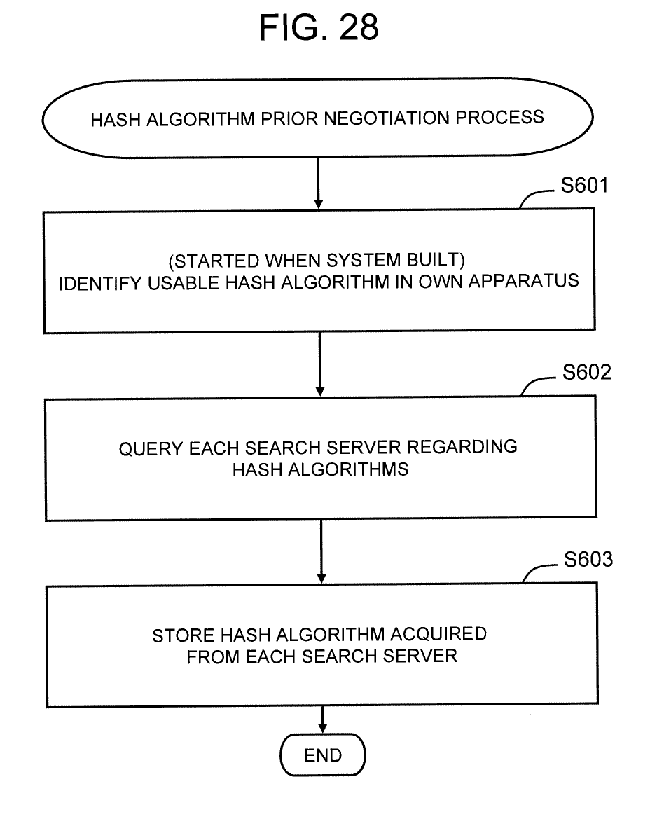

A third example will be explained by referring to FIGS. 27 and 28. In the above-described first example, the search server 1100, which receives an integrated search request, negotiates with the other search servers 1100, 1200, 1300 with respect to a hash algorithm each time an integrated search process is carried out. However, as described in the second example, the hash algorithm is not changed very often. Consequently, in this example, as will be explained hereinbelow, when the system that provides the integrated search service is built, the search server 1100 respectively acquires a usable hash algorithm from each search server 1100, 1200, 1300, and registers these hash algorithms beforehand inside the search server 1100.

The same changes must be made with respect to the search server management table 4300 as were explained using FIG. 25 for the second example. Since the changes contents are the same as those of FIG. 25, explanations thereof will be omitted. A process for registering a hash algorithm beforehand will be added anew to the integrated search control program 1125 in the search server 1100.

FIG. 27 shows the configuration of the computer programs of the search server 1100. In FIG. 27, in addition to the configuration shown in FIG. 3, a hash algorithm prior negotiation subprogram 1178 has been added anew inside the integrated search control program 1125.

The hash algorithm prior negotiation subprogram 1178 is a process for checking beforehand the hash algorithms being used by the respective search servers 1100, 1200, 1300 at the time the system for providing the integrated search service is built, and storing the results of this check in the search server 1100.

FIG. 28 shows a flowchart of the hash algorithm prior negotiation process executed by the search server 1100. This process is carried out when the respective search servers 1100, 1200, 1300 are being configured in a case where a system for providing an integrated search service is to be built.

First, the search server 1100 identifies a usable hash algorithm with respect to the search server 1100 (S601). Identification can be carried out by checking the hash algorithms 4151 and 4153 in the search index registration file management table 4100 managed by the search server 1100.

The search server 1100 queries all the search servers 1100, 1200, 1300 registered in the search server management table 4300 regarding hash algorithms (S602). The hash algorithm query request parameter 6300 is used in this query.

The search server 1100 acquires the information included in the hash algorithm query response parameter 6400 from the query-destination search servers 1100, 1200, 1300. The search server 1100 registers the respective hash algorithm identification information in the search server management table 4300 (S603).

Being configured as described above, this example achieves the same effect as the first example. In addition, in this example, hash algorithm-related information is collected from each search server and stored at the time the system for providing the integrated search service is built. Therefore, there is no need to carry out a hash algorithm negotiation process each time an integrated search request is received, thereby making it possible to shorten integrated search overhead.

### Example 4

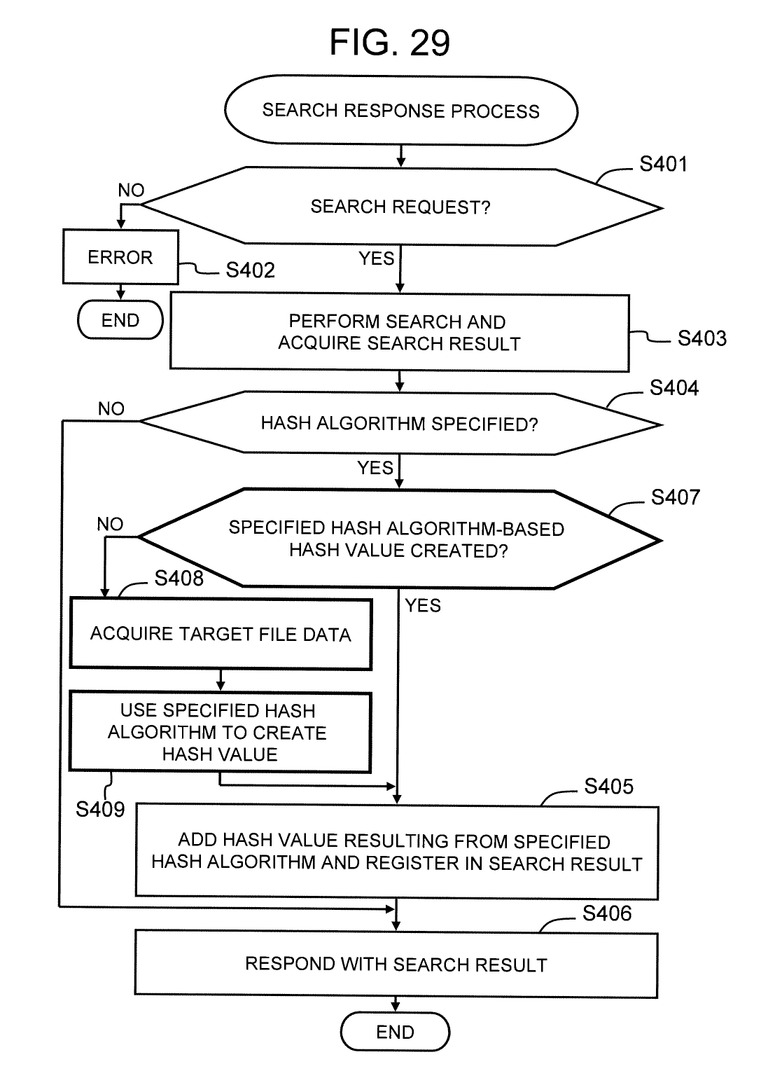

A fourth example will be explained by referring to FIG. 29. In the first example described hereinabove, a hash value is created for search-target file data when search index update processing is carried out for each search server 1100, 1200, 1300. Alternatively, in this example, as will be explained hereinbelow, a hash value is created at the time of a search process. Consequently, in this example, the overhead of the search index update process can be reduced, and, in addition, the need for an area to store a hash value can be done away with.

In this example, upon receiving a search request, the search server begins searching for file data that matches the search condition, and creates on demand a hash value for this file data.

FIG. 29 shows a flowchart of search response processing in the search server. This process comprises S401 through S406 shown in FIG. 22, and, in addition, S407 through S409 have been added anew between S404 and S405. Hereinafter, it is supposed that the subject is the search server 1200 the same as in FIG. 22.

In a case of a search request in which the hash algorithm has been specified (S404: YES), the search server 1200 determines whether or not a hash value has been created using the specified hash algorithm (S407). The search server 1200 checks whether or not a target file hash value has been registered in the column of the target file hash algorithm 4150 of the search index registration file management table 4100.

In a case where a hash value has been created (S407: YES), the processing moves S405. Alternatively, in a case where a hash value has not been created (S407: NO), the search server 1200 acquires the target file data (S408). The search server 1200 may use the file data acquired via crawling to update the search index, or may acquire the target file data from the file server once again.

After acquiring the target file data, the search server 1200 uses the specified hash algorithm to create a hash value based on the target file data (S409). Upon creating the hash value, the search server 1200 moves to S405.

Configuring this example like this also achieves the same effect as the first example. In addition, in this example, a hash value of the file matching the search condition is created on the spot at the point in time that the search request is received. Therefore, in this example, there is no need to create a hash value during the search index update process or to store this hash value.

### Example 5

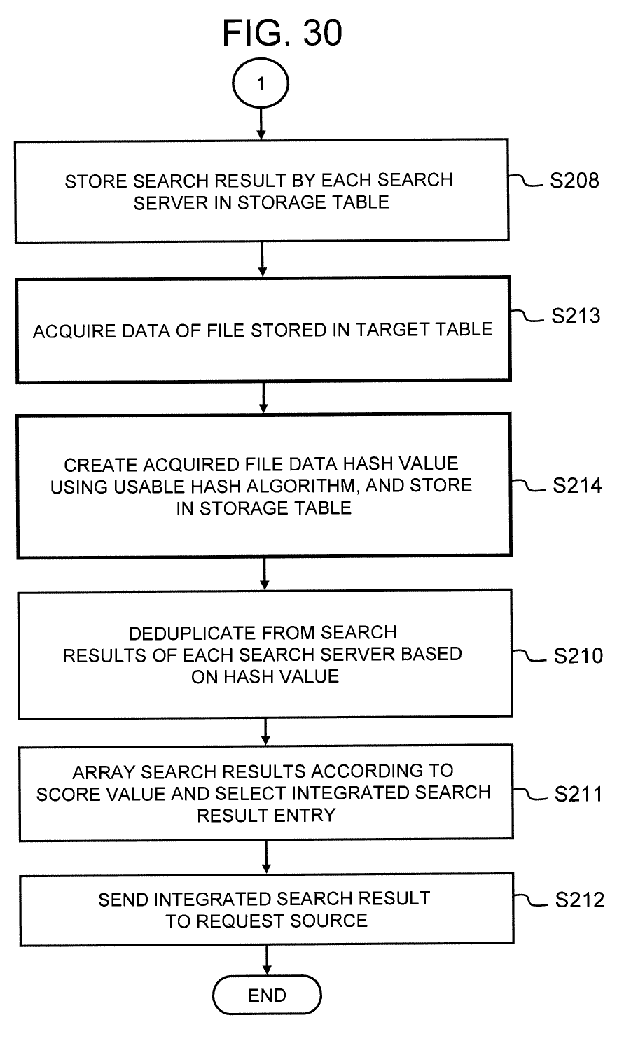

A fifth example will be explained by referring to FIG. 30. In the fourth example described hereinabove, a hash value is created with respect to a search-target file when search processing is being carried out by each search server 1100, 1200, 1300. However, there may be case in which so-called on-demand hash value creation is not possible due to machine performance or the processing loads of the respective search servers.

Consequently, in this example, a hash value is created in the search server 1100 that received the integrated search request with respect to a file retrieved by each search server 1100, 1200, 1300. In accordance with this, in this example it is possible to reduce overhead at search processing time and to do away with an area for storing a hash value in each search server 1100, 1200, 1300.

FIG. 30 shows a partial flowchart of integrated search processing in the search server 1100. The flowchart corresponds to the flowchart shown in FIG. 20. The description will focus on the differences.

The search server 1100 acquires file data stored in an entry of the temporary storage table for search results integration 4400 (S213). The search server 1100, based on the file pathname 4450 of the temporary storage table for search results integration 4400, may directly acquire file data from a file server. Or, in a case where target file cache data is stored inside the search server 1100, the search server 1100 may use this cache data.

The search server 1100 uses a hash algorithm capable of being used in common by the respective search servers to create a hash value for each piece of file data acquired in S213, and registers these hash values in the temporary storage table for search results integration 4400 (S214). The search server 1100 stores the common hash algorithm identification information and the created hash values in the hash algorithm 4460 column and the hash value 4470 column of the temporary storage table for search results integration 4400.

Configuring this example like this achieves the same effect as the first example. In addition, in this example, the search server 1100 creates the hash value of the file that matches the search condition on the spot at the time the integrated search request is received. Therefore, in this example, in a case where it is not possible to create a hash value in each search server because the processing load will become too high, the search server that received the integrated search request can collectively create the hash values.

In addition, in this example, the burden of hash value creation can be changed in accordance with the load status of each search server. For example, in the case of a low-load search server, it is possible to create a hash value inside this search server, and in the case of a high-load search server, it is possible to have the search server that received the integrated search request (or another search server) create the hash value.

### Example 6

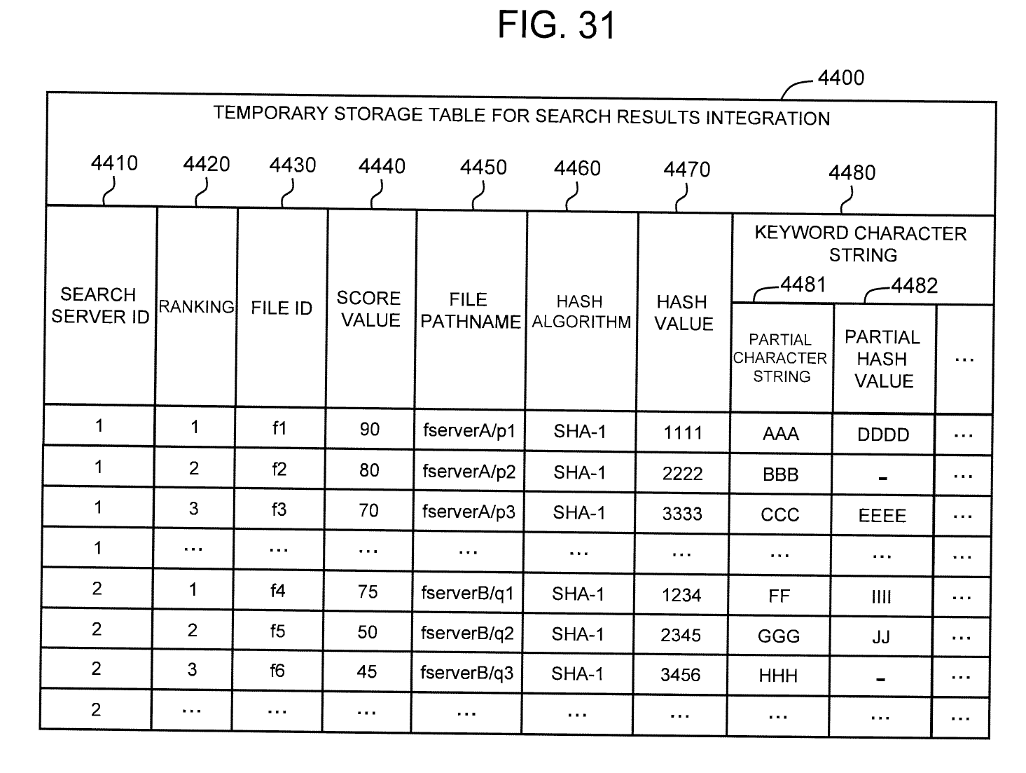

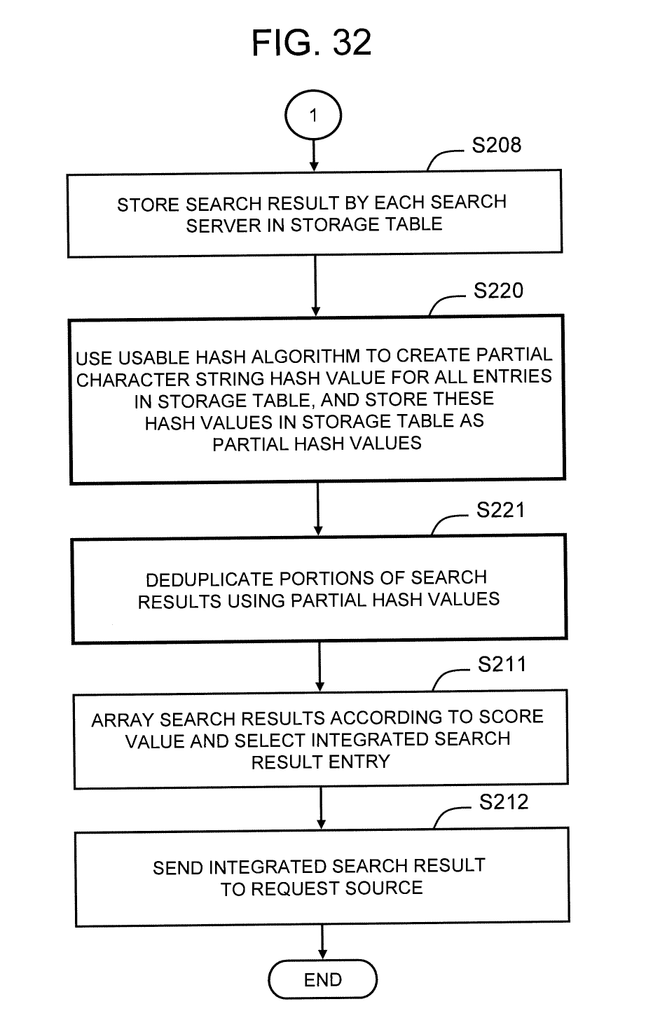

A sixth example will be explained by referring to FIGS. 31 and 32. In the fifth example described hereinabove, the search server 1100 creates a hash value for target file data when integrated search processing is being carried out by this search server 1100.

However, there is a possibility that the search server 1100, which receives the integrated search request, will not be able to access the file server that is storing the target file data. In this case, the search server 1100, which received the integrated search request, will not be able to acquire the file data that matches the search condition.

Consequently, a character string containing a search keyword, which each search server provides as a portion of the search result, is used instead of using the file data. This example is used for creating a hash value based on the search keyword character string to detect and eliminate a duplicate entry from the integrated search result. This makes it possible to find and eliminate a duplicate entry from the integrated search result in a case where either the search server 1100, which received the integrated search request, is unable to access the file server, or it is not possible to create hash values in the respective search servers 1100, 1200, 1300 because of high processing loads.

FIG. 31 shows the temporary storage table for search results integration 4400. The temporary storage table for search results integration 4400 of FIG. 31 differs from the temporary storage table for search results integration 4400 shown in FIG. 11 in that a partial character string 4481 and a partial hash value 4482 have been added anew to the search keyword character string 4480.

The partial character string 4481 is information that was originally stored in the search keyword character string 4480 in the temporary storage table for search results integration 4400 shown in FIG. 11. A hash value created from the partial character string 4481 is stored in the partial hash value 4482.

The partial hash value 4482 may be created using a hash algorithm that has been registered in the hash algorithm 4440 of the temporary storage table for search results integration 4400. Or, the partial hash value 4482 may be created by selecting one arbitrary hash algorithm that is capable of being used in the search server 1100 and using this hash algorithm.

Multiple sets of the partial character string 4481 and the partial hash value 4482 stored in the search keyword character string 4480 can be stored with respect to each entry. Furthermore, the null value may be stored in the column of the search keyword character string 4480 in a case where a blank space occurs with respect to either the partial character string 4481 or the partial hash value 4482.

FIG. 32 shows a portion of a flowchart of integrated search processing executed by the search server 1100. This process creates on demand a hash value with respect to a search keyword character string included in the search results.

In FIG. 32, after S208 the search server 1100 uses the hash algorithm that is capable of being used in the search server 1100 to create a hash value from a partial character string that is being stored in an entry of the temporary storage table for search results integration 4400, and registers this hash value in the temporary storage table for search results integration 4400 as the partial hash value (S220).

In a case where multiple partial character strings are being stored in the partial character string 4481 with respect to an entry of the temporary storage table for search results integration 4400 here, the search server 1100 respectively creates a partial hash value for all of these partial character strings, and stores these partial hash values in the partial hash value 4482 column.

The search server 1100 uses the partial hash value to detect and eliminate a duplicate entry and eliminate from the integrated search result (S221).

The search server 1100 is able to determine that entries for which all of the partial hash values are a match are duplicate entries. Or, the search server 1100 may determine that entries for which a certain percentage or more of the partial hash values are a match are quasi-duplicate entries. For example, the configuration may be such that two entries for which partial hash values of equal to or larger than m number of hash values of n partial hash values (0<m<n) match be determined to be duplicate entries.

Configuring this example like this achieves the same effect as the first example. In addition, this example is used to detect a duplicate entry by determining a hash value from a character string that comprises a search keyword (that is, a portion of the file data) instead of determining a hash value from the file data. Therefore, it is possible to find and eliminate a duplicate entry from the integrated search result in a case where either the search server 1100 is unable to access the file server, or a hash algorithm that is common to the search servers 1100, 1200, 1300 could not be determined.

### Example 7

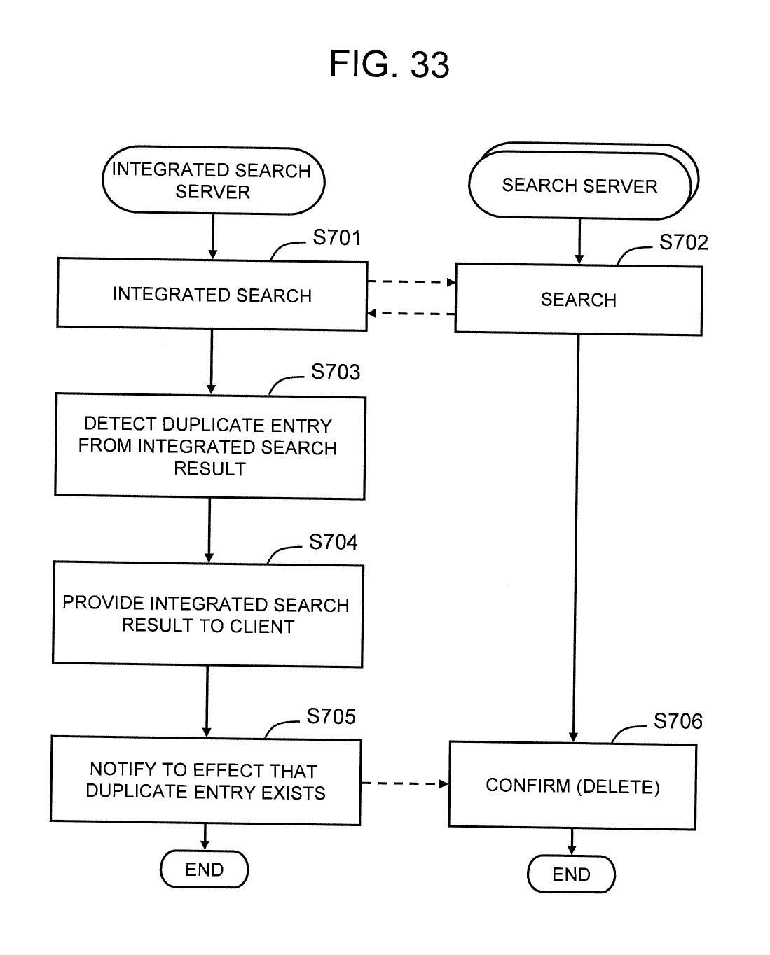

A seventh example will be explained by referring to FIG. 33. In this example, in a case where a duplicate entry has been detected in the integrated search result, the search server, which manages the search index corresponding to this duplicate entry, is notified that a duplicate entry exists.

FIG. 33 is the processing in a case where a duplicate entry has been discovered. A representative search server 1100 is a search server for receiving an integrated search request and carrying out an integrated search. The search servers (1100, 1200, 1300) are search servers that participate in the integrated search and carry out searches in accordance with a search request from the representative search server 1100.

The representative search server 1100, upon receiving an integrated search request from the client machine, issues a search request to the respective search servers (S701). Each search server carries out a search in accordance with the search request, and returns a search result to the representative search server 1100 (S702). The representative search server 1100 uses a hash value to detect a duplicate entry in the integrated search result (S703).

The representative search server 1100 removes the duplicate entry and sends the client machine the integrated search result (S704). In addition, the representative search server 1100 notifies the search server with respect to which the duplicate entry was discovered to the effect that a duplicate entry had been discovered (S705). The search server that receives this notification confirms the duplicate entry (S706). The search server is also able to instruct the file server to delete the file corresponding to the duplicate entry.

Configuring this example like this also achieves the same effect as the first example. In addition, in this example, it is also possible to delete a duplicate file because the search server is notified to the effect that a duplicate entry was detected in the integrated search result.

The present invention is not limited to the above-described embodiment. A person having ordinary skill in the art will be able to make various additions and changes without departing from the scope of the present invention. For example, the configuration may also be such that, in a case where a hash algorithm that is shared in common by multiple search servers cannot be found, a hash algorithm capable of becoming this common hash algorithm is sent to and installed in a search server that does not comprise a hash algorithm capable of becoming the common hash algorithm.

What is claimed is:

1. A method for searching in use of a computer system including multiple search servers,
the computer system being configured by loosely coupling the multiple search servers each operating independently,
the search method comprising:
a step in which an integrated search server, which is included among the multiple search servers, upon receiving an integrated search request to have multiple prescribed search servers included among the multiple search servers carry out respective searches, determines duplicate detection information, which can be used in common by the respective prescribed search servers and which is for detecting duplication, and issues a search request corresponding to the integrated search request to the respective prescribed search servers;
a step in which each of the prescribed search servers searches a data group each of the prescribed search servers is responsible for on the basis of the search request, includes in a result of the search a duplicate detection value, which is created using the duplicate detection information that has been determined and which is for detecting duplication, and sends this search result to the integrated search server; and
a step in which the integrated search server, based on the respective duplicate detection values, detects duplicate data from among the search results received from the prescribed search servers, removes the detected duplicate data from the respective search results in order to create an integrated search result, and provides this integrated search result to the source of the integrated search request.

2. A search method according to claim 1, wherein the respective prescribed search servers each store beforehand the duplicate detection value for each of multiple duplicate detection information items with respect to the data group for which the prescribed search server is responsible, include in the search result a duplicate detection value corresponding to the duplicate detection information determined by the integrated search server from among stored the duplicate detection values and sends this search result to the integrated search server.

3. A search method according to claim 2, wherein each of the prescribed search servers, when updating a search index, which is used for searching the data group for which each of the prescribed search servers is responsible, respectively creates and stores the duplicate detection value for each of the multiple duplicate detection information items.

4. A search method according to claim 1, wherein each of the integrated search servers acquires from each of the prescribed search servers information related to duplicate detection information that can be used by each of the prescribed search servers and stores the same, and upon receiving the integrated search request, determines, based on information related to the stored duplicate detection information, duplicate detection information that the prescribed search servers can use in common.

5. A search method according to claim 1, wherein the integrated search server, when the computer system is to be built, acquires from each of the prescribed search servers information related to duplicate detection information that can be used by the prescribed search servers and stores the same, and upon receiving the integrated search request, determines, based on information related to the stored duplicate detection information, duplicate detection information that the prescribed search servers can use in common.

6. A search method according to claim 1, wherein each of the prescribed search servers, in a case where the search request has been received from the integrated search server, creates the duplicate detection value in accordance with the determined duplicate detection information, includes this duplicate detection value in the search result, and sends this search result to the integrated search server.

7. A search method according to claim 1, wherein the duplicate detection information is a hash algorithm, and the duplicate detection value is a hash value.

8. An integrated search server for searching in use of a computer system configured by loosely coupling multiple search servers each operating independently, wherein
the integrated search server, upon receiving an integrated search request to have multiple prescribed search servers, included among the multiple search servers, carry out respective searches,
determines duplicate detection information, which can be used in common by the respective prescribed search servers and which is for detecting a duplicate,
issues to the respective prescribed search servers a search request, specifying the determined duplicate detection information and corresponding to the integrated search request,
receives from each of the prescribed search servers a search result, which is obtained by each prescribed search server searching a data group each prescribed search server is responsible for, and which includes a duplicate detection value, which is created using the determined duplicate detection information and which is for detecting duplication, and
detects, based on the respective duplicate detection values, duplicate data from among the search results received from the prescribed search servers,
removes the detected duplicate data in order to create an integrated search result, and
provides this integrated search result to the source of the integrated search request.

9. An integrated search server according to claim 8, wherein the integrated search server acquires from each of the prescribed search servers information related to duplicate detection information that can be used by each of the prescribed search servers and stores the same, and upon receiving the integrated search request, determines, based on the information related to each of stored duplicate detection information items, duplicate detection information that the respective prescribed search servers can use in common.

10. An integrated search server according to claim 8, wherein, when the computer system is to be built, the integrated search server, acquires from each of the prescribed search servers information related to duplicate detection information that can be used by the each of the prescribed search servers and stores the same, and upon receiving the integrated search request, determines, based on the information related to each of stored duplicate detection information items, duplicate detection information that the respective prescribed search servers can use in common.

11. An integrated search server according to claim 8, wherein each of the prescribed search servers, upon receiving the search request from the integrated search server, creates the duplicate detection value in accordance with the determined duplicate detection information, includes this duplicate detection value in the search result, and sends this search result to the integrated search server.

12. A computer program for causing a computer to function as an integrated search server for searching in use of a computer system which is configured by loosely coupling multiple search servers each operating independently,
the computer program causing the computer to:
receive an integrated search request to have multiple prescribed search servers included among the multiple search servers carry out respective searches;
determine duplicate detection information, which can be used in common by the respective prescribed search servers and which is for detecting duplication;
issue to the respective prescribed search servers a search request, which specifies the determined duplicate detection information and corresponds to the integrated search request;
receive from each of the prescribed search servers a search result, which is obtained by each prescribed search server searching a data group each prescribed search server is responsible for, and which includes a duplicate detection value, which is created using the determined duplicate detection information and which is for detecting duplication;
detect, based on the respective duplicate detection values, duplicate data from among the search results received from the prescribed search servers,
remove the detected duplicate data in order to create an integrated search result; and
provide this integrated search result to the source of the integrated search request.

13. A computer program according to claim 12, which causes the computer to:
acquire from each of the prescribed search servers information related to duplicate detection information that can be used by each of the prescribed search servers and store the same; and
upon receiving the integrated search request, determine, based on the information related to each of stored duplicate detection information items, duplicate detection information that the respective prescribed search servers can use in common.

14. A computer program according to claim 12, which causes the computer to:
acquire from each of the prescribed search servers, when the computer system is to be built, information related to duplicate detection information that can be used by each of the prescribed search servers and store the same; and
upon receiving the integrated search request, determine, based on the information related to each of the stored duplicate detection information items, duplicate detection information that the respective prescribed search servers can use in common.

15. A computer program according to claim 12, wherein the duplicate detection information is a hash algorithm, and the duplicate detection value is a hash value.
